(19) United States
(12) Patent Application Publication
(10) Pub. No.: US 2009/0268376 A1
(43) Pub. Date: Oct. 29, 2009

(54) ELECTROLYTES AND CAPACITORS

(75) Inventors: Howard Stuart Atkin, Harrogate (GB); Ian David Nickson, Lancashire (GB)

Correspondence Address: BAKER & DANIELS LLP, 300 NORTH MERIDIAN STREET, SUITE 2700, INDIANAPOLIS, IN, 46204, US

(73) Assignee: Add Power Technologies Limited, Harrogate (GB)

(21) Appl. No.: 12/374,386

(22) PCT Filed: Jul. 23, 2007
(86) PCT No.: PCT/GB2007/002796

§ 371 Date: Jan. 20, 2009

(30) Foreign Application Priority Data
Jul. 21, 2006 (GB) 0614486.9

(51) Int. Cl. H01G 9/038; H01G 9/035

(52) U.S. Cl. 361/502; 252/62.2

(57) ABSTRACT

An electrolyte for use in a capacitor. The electrolyte comprising a solvent; a salt comprising a first anion and a first cation; and an additive. The additive is provided in a sufficient quantity to modify a voltage differential across an electric double layer associated with at least one electrode of said capacitor such that said voltage differential is closer to a predetermined voltage breakdown limit for the electrolyte and said at least one electrode than a voltage differential across an electric double layer associated with said at least one electrode and a further electrolyte comprising said solvent and said salt but no additive. A capacitor comprising first and second electrodes and the aforementioned electrolyte. Methods for optimising an electrolyte for use in a capacitor and manufacturing optimised capacitor systems are also presented.

The present invention relates to electrolytes and capacitors, particularly but not exclusively, electrochemical supercapacitors and electrolytes for use in such capacitors. The present invention further relates to a method for selecting the various components of a capacitor to optimise its performance.

In a simple parallel plate capacitor, two metal plates are arranged in face-to-face relationship with a small gap between them. The capacitance of the resultant device is directly proportional to the cross-sectional area of the plates and inversely proportional to the spacing between the plates.

The capacitance of a parallel plate capacitor can be increased by placing a thin layer of electrically insulating dielectric material between the plates. The dielectric constant of the dielectric material determines the electrostatic energy which may be stored in that material per unit volume for a given voltage. The use of such a dielectric layer has the additional benefit of providing a way of ensuring plate separation.

Although for the purposes of explanation reference is made above to parallel plate capacitors, it will be appreciated that the same principles apply to for example cylindrical capacitors in which flexible “plates” separated by flexible sheets of dielectric material are rolled up to form a cylindrical structure.

Electrolytic capacitors are also known in which one terminal of the capacitor is connected to an electrically conductive substrate on a surface of which a thin dielectric layer has been deposited. The other terminal of the capacitor is connected to an electrode which is in electrical contact with an electrolyte that also contacts the dielectric layer. Electrostatic energy is stored in the dielectric layer and in the electrolyte. The energy density of the device is a function of the effective area of the dielectric layer and the area of the electrolyte in contact with the dielectric layer. It is known to increase the effective area by forming the dielectric layer on a porous or sponge-like structure formed on a substrate, for example by forming the dielectric layer on a porous layer of porous metal, metal particles or metal fibres. Electrolyte can penetrate into voids defined between the particles or fibres. Thus the surface area presented by the porous layer to the electrolyte is substantially greater than the area of the plates on which those layers are formed.

Electrochemical capacitors are also known and are generally referred to as “supercapacitors”. In a conventional double-layer supercapacitor, two spaced apart electrodes are provided each of which comprises an electrically conductive substrate upon which a high surface area porous conductive layer has been built up, the porous layer being made of for example carbon particles or fibres. The two electrodes are separated by an electrically insulating separator. The space between the two substrates is flooded with an electrolyte which penetrates into the spaces between the carbon particles or fibres. The separator is an ionic conductor so that, although a direct electrical connection cannot be made between the two porous layers, ions formed in the electrolyte can be conducted through the separator. Such supercapacitors have a very high capacitance per unit volume. However, the maximum energy density of such a device is a function both of capacitance and the square of the applied voltage. With electrochemical capacitors, the maximum voltage that can be applied without damaging the device is of the order of 1 volt if the electrolyte is aqueous or is of the order of 2.5 volts if the electrolyte is a dry organic solvent such as acetonitrile. Given that if for example the maximum applied voltage could be doubled the energy density could be quadrupled increasing the maximum applied voltage would be desirable, but unfortunately it has not proved possible to produce an electrode/electrolyte combination capable of sustaining high voltages.

The electrolytes employed in many electrochemical capacitors often comprise a solvent in to which is dissolved an ionisable salt. When the salt dissolves it ionises such that the application of a voltage across the cell causes the formation of layers of ions within the electrolyte in the vicinity of each electrode.

Many different models have been developed in an attempt to understand the ionic environment in the vicinity of an electrode surface. When the electrode is charged a balancing counter charge develops in the liquid electrolyte. The charges are not uniformly distributed throughout the electrolyte, but will be concentrated near the charged surface of the electrode. Thus, we have a small but finite volume of the electrolyte which is different from the extended liquid.

The simplest model to explain this phenomenon is the Helmholtz double layer model in which a surface charge is neutralized by opposite sign counterions placed at an increment of d away from the surface. The surface charge potential is linearly dissipated from the surface to the counterions satisfying the charge. The distance, d, is that to the centre of the counterions, i.e. their radius. The Helmholtz model does not adequately explain all of the features of real capacitor systems, not least because it assumes rigid layers of opposite charges.

A second more accurate model is the Gouy-Chapman double layer model. Gouy suggested that interfacial potential at the charged surface could be attributed to the presence of a number of ions of given sign attached to its surface, and to an equal number of ions of opposite charge diffused throughout the solution. Gouy and, independently, Chapman developed theories of the diffuse double layer model in which the change in concentration of the counter ions near a charged surface follows a Boltzmann distribution. Unfortunately, in practice the double layer thickness is generally found to be somewhat greater than calculated using this model, which may be due to the error associated with assuming ionic activity equals molar concentration when using the Boltzmann-type charge distribution.

The Gouy-Chapman theory provides a better approximation of reality than the Helmholtz theory, but it still has limited quantitative application. The Gouy-Chapman theory assumes that ions behave as point charges, and it assumes that there are no physical limits for the ions in their approach to the surface. Stern modified the Gouy-Chapman diffuse double layer model to develop a new theory which assumes that ions have finite size and that it is possible that some of the ions are specifically adsorbed by the surface in a plane which has become known as the Stem Layer. The double layer causes an electrokinetic potential between the surface and the liquid electrolyte. This surface potential is related to the surface charge and the thickness of the double layer. The potential drops off roughly linearly in the Stem layer and then exponentially through the diffuse layer, approaching zero at the imaginary boundary of the double layer.

It will be appreciated from the foregoing discussion that the behaviour of electrochemical capacitor systems is complex and that many different components of the capacitor interact to influence the performance of the device. There is therefore much work still to be done to fully understand and predict capacitor operation. While it is clear that the choice of electrode materials, electrolyte and salt are all critical to optimising the operating voltage of the capacitor, this lack of detailed understanding is a significant problem when developing new and improved electrolytes and capacitors.

The object of the present invention is to obviate or mitigate one or more of the above problems.

According to a first aspect of the present invention there is provided an electrolyte for use in a capacitor, the electrolyte comprising a solvent; a salt comprising a first anion and a first cation; and an additive, wherein the additive is provided in a sufficient quantity to modify a voltage differential across an electric double layer associated with at least one electrode of said capacitor such that said voltage differential is closer to a predetermined voltage breakdown limit for the electrolyte and said at least one electrode than a voltage differential across an electric double layer associated with said at least one electrode and a further electrolyte comprising said solvent and said salt but no additive.

It has been unexpectedly observed that the theoretical maximum operational voltage window of a capacitor can be achieved by adding to the capacitor electrolyte a sufficient quantity of an additive to modify the voltage differential across the electric double layer which exists in the vicinity (i.e. within less than around 5 nm, more preferably within less than around 2 nm) of each electrode of the capacitor so as to more closely match the voltage breakdown limit for the electrolyte and each electrode. This advantageous effect is exemplified below in the Examples.

While the inventor does not wish to be bound by any particularly theory it is believed that by adding a suitable amount of the additive, the additive ions/molecules (depending on whether the additive is an ionisable or non-ionisable species) modify the packing arrangement of the salt ions and solvent molecules in the charged double layer in the vicinity of one or both electrodes of the capacitor so as to enable the optimisation of the operational voltage window of the capacitor for a particular application.

When a supercapacitor has a voltage applied across its electrodes it charges. This involves the separation of the ions in solution with the positive ions migrating towards the negative electrode (often termed the cathode) and the negative ions migrating to the positive electrode (often termed the anode). Separation of the positive and negative ions results in an electrochemical double layer being formed in the vicinity of each of the electrodes. There are numerous parameters that can affect the structure of this double layer including the size, charge and shape of the ions, and the applied voltage that is supporting the layer. Again, the inventor does not wish to be bound by any particular theory but it is believed that the packing of the ions within the each double layer governs, at least in part, the capacitance of the electrode. Hence, if the packing of the ions within a double layer is disturbed the capacitance of the electrode associated with that double layer will be altered.

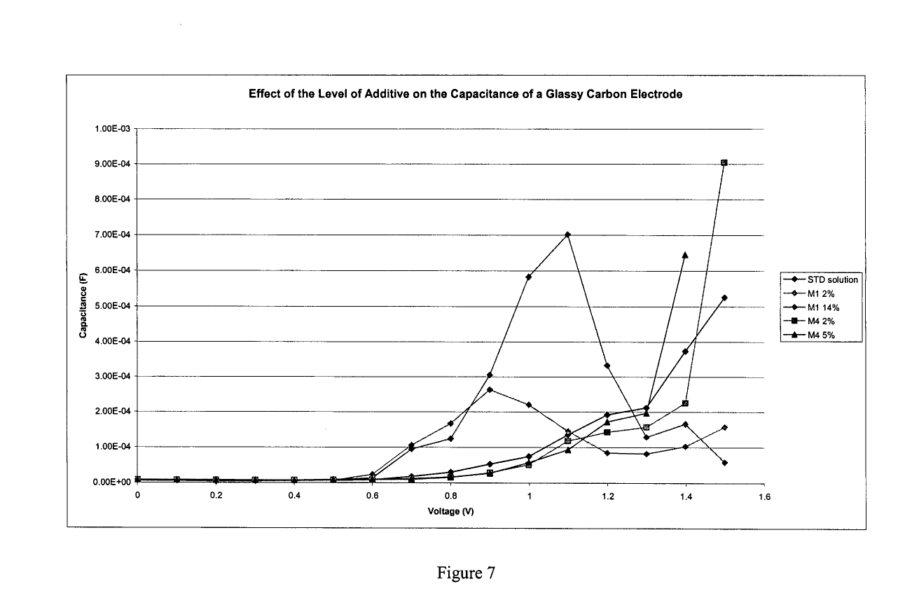

As described below in Example 9, it is possible to measure the capacitance of an electrode using AC impedance techniques. In Example 9 a glassy carbon electrode of known area was used. The result presented below in FIG. 7 show the effect of the additives on the capacitance of the electrode at varying voltages. The results clearly indicate that the additives are altering the structure of the double layer and hence causing the observed changes in the measure capacitance.

Using the optimised electrolyte of the present invention obviates the need to reduce the surface area of one electrode relative to the other electrode in an attempt to achieve a similar effect, which actually undesirably reduces the total electrode area exposed to the electrolyte and therefore reduces the capacitance of the capacitor.

The electrolyte of the present invention may be considered as an electrolyte that is optimised to suit a particular capacitor system to make up for previously unappreciated losses in charge storage capacity resulting from the voltage differential across the electric double layer associated with each electrode not matching the voltage breakdown limit for the electrolyte and each electrode. This lack of matching can be seen in the results presented in the Examples for conventional electrolytes not including any additive where the positive and negative voltage differentials are much lower than the positive and negative voltage breakdown limits. The results also clearly demonstrate that addition of even a small amount of additive more closely matches the positive/negative voltage differentials to the positive/negative breakdown limits, thereby enabling the optimised electrolyte to operate at a higher applied voltage and thus increase the charge storage capacity of the capacitor.

It is envisaged that the electrolyte of the present invention can be used to compensate for losses in capacitance exhibited by many commercially available parallel plate capacitors which, due to manufacturing tolerances, may incorporate one electrode of sub-optimal surface area, and cylindrical capacitors which, due to their very structure, include one electrode of lower surface area than the opposite electrode.

It is preferred that the additive is provided in a sufficient quantity such that said voltage differential substantially matches the predetermined voltage breakdown limit.

Preferably the additive is provided in a sufficient quantity to at least partially offset a reduction in the voltage differential across said at least one electric double layer compared to the predetermined voltage breakdown limit for the electrolyte that is attributable to the nature of the electrolyte solvent and salt.

In a preferred embodiment the additive is provided in a sufficient quantity to at least partially offset a reduction in the voltage differential across said at least one electric double layer compared to the predetermined voltage breakdown limit of the electrolyte that is attributable to said at least one electrode possessing a surface area that is less than a predetermined optimum surface area for said at least one electrode.

As mentioned above, it is typically the case that electrodes employed in commercially available capacitors possess surfaces areas that are less than optimum for the particular electrode/electrolyte system in which they are used. The electrodes may possess surfaces areas that are less than optimum for example because of the physical nature of the capacitor (e.g. a coil-type capacitor will inherently incorporate unequal surface area electrodes), slight inaccuracies in the manufacturing methods employed to produce the electrodes, or the physical nature of electrode material used, e.g. it can be very difficult to accurately control the effective surface area of an electrode exposed to an electrolyte when the electrode is formed from a highly porous material.

Preferably the additive is provided in a sufficient quantity to modify first and second voltage differentials across electric double layers associated with respective first and second electrodes of said capacitor such that said first voltage differential is closer to a first predetermined voltage breakdown limit for the electrolyte and said first electrode than a third voltage differential across an electric double layer associated with said first electrode and said further electrolyte and said second voltage differential is closer to a second predetermined voltage breakdown limit for the electrolyte and said second electrode than a fourth voltage differential across an electric double layer associated with said second electrode and said further electrolyte.

It is particularly preferred that the additive is provided in a sufficient quantity such that said first and second voltage differentials substantially match said first and second predetermined voltage breakdown limits respectively.

The additive is preferably provided in a sufficient quantity to at least partially offset a reduction in at least one of the first and second voltage differentials compared to the respective first and second predetermined voltage breakdown limits that is attributable to said first and second electrodes possessing unequal surface areas.

It is preferred that the concentration of the additive in the electrolyte is less than the concentration of the salt in the electrolyte. Preferably the concentration of the additive in the electrolyte is up to about 75%, more preferably up to about 50%, still more preferably up to about 25% of the concentration of the salt in the electrolyte. Yet more preferably the concentration of the additive in the electrolyte is up to about 10%, and most preferably about 5 to 10% of the concentration of the salt in the electrolyte.

Preferably the radius (i.e. molecular radius if the additive is non-ionisable, or ionic radius of at least one of the additive anions and additive cations if the additive is ionisable) of the additive species present in the electrolyte is different to at least one of the molecular radius of the solvent molecules and the ionic radius of at least one of the first anion and the first cation.

A second aspect of the present invention provides a capacitor comprising first and second spaced electrodes and an electrolyte provided in the space defined between the electrodes, the electrolyte comprising a solvent; a salt comprising a first anion and a first cation; and an additive, wherein the additive is provided in a sufficient quantity to modify a voltage differential across an electric double layer associated with at least one electrode of said capacitor such that said voltage differential is closer to a predetermined voltage breakdown limit for the electrolyte and said at least one electrode than a voltage differential across an electric double layer associated with said at least one electrode and a further electrolyte comprising said solvent and said salt but no additive.

A third aspect of the present invention provides a method for optimising an electrolyte for use in a capacitor comprising an anode, a cathode and an electrolyte comprised of a solvent, a salt comprising a first anion and a first cation, and an additive, the method comprising the steps of:
selecting an anode structure, a cathode structure and an electrolyte composition;
determining a positive voltage breakdown limit for the selected anode structure and electrolyte;
determining a negative voltage breakdown limit for the selected cathode structure and electrolyte;
arranging a test rig comprising a quantity of the selected electrolyte, a test anode having the selected anode structure and a test cathode having the selected cathode structure;
applying a voltage between the test anode and the test cathode;
varying the amount of the additive in the electrolyte composition to modify the voltage differential between the electrolyte and at least one of the test anode and the test cathode;
measuring a potential difference between the test anode and the electrolyte and a potential difference between the test cathode and the electrolyte for each of a plurality of different combinations of applied voltage and electrolyte compositions; and

using said measurements to select the optimum electrolyte composition for use in the capacitor in which the voltage differential between the electrolyte and said at least one of the test anode and the test cathode is closer to the corresponding positive and/or negative voltage breakdown limit than a further capacitor comprising an anode and a cathode having the same structures as the test anode and test cathode respectively and employing a further electrolyte comprised of said solvent and said salt but no additive.

Preferably, the selected electrolyte composition is the composition at which the largest voltage could be applied between the test anode and test cathode with the potential difference between each of the test anode and test cathode and the electrolyte not exceeding the respective voltage breakdown limit.

The third aspect of the present invention can thus be regarded as a method of optimizing an electrolyte so as to achieve the optimum operating voltage (i.e. operational voltage window or withstanding voltage) of a capacitor.

It will be appreciated that a method in accordance with the third aspect of the present invention may be used in the production of an electrolyte in accordance with the first aspect of the present invention and/or the production of a capacitor in accordance with the second aspect of the invention.

A fourth aspect of the present invention provides a method for manufacturing an electrochemical capacitor comprising an anode, a cathode, and an electrolyte, the method comprising optimising the electrolyte using an optimisation method in accordance with the third aspect of the invention and constructing the capacitor with the selected anode and cathode structures and the selected electrolyte composition.

Although the present invention is suitable for use with electrodes of any desirable structure and composition, having equal or unequal surface areas, it is preferred that at least one, more preferably both, electrodes in the above mentioned capacitors comprise a carbonaceous material. It is particularly preferred that both electrodes are graphite, and more preferably, high surface area porous graphite. Each electrode may be manufactured from glassy carbon.

A fifth aspect of the present invention provides use of an additive in an electrolyte to modify a voltage differential across an electric double layer associated with at least one electrode of a capacitor, the electrolyte further comprising a solvent and a salt comprising a first anion and a first cation, wherein the additive is provided in a sufficient quantity to modify said voltage differential across the electric double layer associated with said at least one electrode of said capacitor such that said voltage differential is closer to a predetermined voltage breakdown limit for the electrolyte and said at least one electrode than a voltage differential across an electric double layer associated with said at least one electrode and a further electrolyte comprising said solvent and said salt but no additive.

It will be appreciated that the electrolyte employed in the fifth aspect of the present invention may have the same composition as the electrolyte forming the first aspect of the present invention.

The fifth aspect of the present invention provides a means by which a suitable additive provided in an appropriate amount can be used to tailor the performance of a capacitor to any desirable application. In particular, it will be appreciated that the additive can be used to modify an electric double layer associated with an electrode of a capacitor so as to increase the operational voltage window of the capacitor and thereby increase the energy storage capacity of the capacitor.

The above defined aspects of the present invention demonstrate how the complexities inherent in the production of electrolytes and the fabrication of capacitors can be overcome in real practical systems to optimise (particularly, but not exclusively, maximise) energy storage and operating voltages without compromising the life of the electrolyte.

In a first preferred embodiment of the first aspect of the present invention the additive comprises at least one of a second anion of larger ionic radius than the first anion, the concentration of the second anion being lower than the concentration of the first anion; and a second cation of larger ionic radius than the first cation, the concentration of the second cation being lower than the concentration of the first cation.

The electrolyte salt is provided so as to ionise under the operating conditions of the capacitor in which the electrolyte is used to provide anions of a first type and cations of a first type within the electrolyte. In the above first preferred embodiment, the additive in the electrolyte provides a second type of anion of larger ionic radius than the first anion and/or a second cation of larger ionic radius than the first cation. Preferably, the additive is a salt which provides both second anions and second cations, although it will be appreciated that the additive may be a salt which provides only one of the second anions and second cations.

It is particularly preferred that the additive is a salt which ionises under the application of an electric field to provide both the second anions and the second cations in which case the second anions and second cations (provided by the additive) must have respective ionic radii which are larger, preferably significantly larger, than the ionic radii of the first anions and cations respectively.

It is preferred that the ionic radius of the second anion is at least about 10% larger than the ionic radius of the first anion. More preferably the second anion has an ionic radius which is at least about 25% larger than that of the first anion. Still more preferably the second anion possesses an ionic radius which is at least 50% larger than the ionic radius of the first anion. In preferred embodiments the ionic radius of the second anion is about 20 to 200% larger, more preferably about 40 to 150% larger, and most preferably about 60 to 100% larger than the ionic radius of the first anion. It is particularly preferred that the second anion possesses an ionic radius which is about 75 to 125% larger than the ionic radius of the first anion.

Preferably the ionic radius of the second cation is at least about 10% larger than the ionic radius of the first cation. More preferably the second cation has an ionic radius which is at least about 25% larger than that of the first cation. Yet more preferably the second cation possesses an ionic radius which is at least 50% larger than the ionic radius of the first cation. It is preferred that the ionic radius of the second cation is about 40 to 400% larger, more preferably about 80 to 350% larger, and still more preferably about 100 to 300% larger than the ionic radius of the first cation. It is especially preferred that the second cation possesses an ionic radius which is about 150 to 250% larger than the ionic radius of the first cation.

The above first preferred embodiment of the present invention further requires that when the additive provides anions of the second type the concentration of the second anions in the electrolyte is less than the concentration of the first anions in the electrolyte and that when the additive provides cations of the second type the concentration of the second cations is less than the concentration of the first cations.

Preferably the concentration of the salt in the electrolyte is up to about 4 M, more preferably about 0.1 to 3.0 M, still more preferably about 0.5 to 2.0 M. It is particularly preferred that the concentration of the salt in the electrolyte is in the range about 0.5 to 1.5 M, and most preferably about 0.75 to 1.0 M.

It is preferred that the concentration of the second anions is less than about 75%, more preferably less than about 50%, and most preferably less than about 25% of the concentration of the first anions. It is particularly preferred that the electrolyte contains only a small amount of second anions relative to the amount of first anions present in the electrolyte. The concentration of the second anions in the electrolyte is preferably at least about 1% of the concentration of the first anions, more preferably at least about 4%, still more preferably at least about 7%, and most preferably at least about 10% of the concentration of the first anions. It is particularly preferred that the concentration of the second anions in the electrolyte is about 4 to 10% of the concentration of the first anions, still more preferably about 6 to 8% of the concentration of the first anions.

The concentration of the second cations is preferably less than about 75%, yet more preferably less than about 50%, and still more preferably less than about 25% of the concentration of the first cations. It is particularly preferred that the electrolyte contains only a small amount of second cations relative to the amount of first cations present in the electrolyte. The concentration of the second cations in the electrolyte is preferably at least about 1% of the concentration of the first cations, more preferably at least about 4%, yet more preferably at least about 7%, and most preferably at least about 10% of the concentration of the first cations. It is particularly preferred that the concentration of the second cations in the electrolyte is about 4 to 10%, still more preferably about 6 to 8% of the concentration of the first cations.

It will be appreciated that where the additive is a salt which provides both second anions and second cations, and the additive salt ionises to provide anions and cations in a 1:1 stoichiometric ratio, the concentration of the second anions in the electrolyte will be the same as the concentration of the second cations in the electrolyte, which will, of course, be the same as the concentration of the additive salt provided in the electrolyte. Thus, where the additive is such a salt, it is preferred that the concentration of the additive salt in the electrolyte is at least about 1% of the concentration of the electrolyte salt, more preferably at least about 4%, still more preferably at least about 7% and most preferably about 10% of the concentration of the electrolyte salt. In a particularly preferred embodiment the concentration of the additive salt in the electrolyte is about 4 to 10% of the concentration of the electrolyte salt, and most preferably about 6 to 8% of the concentration of the electrolyte salt.

In the first preferred embodiment of the electrolyte of the invention described above, the electrolyte comprises a solvent, a salt and an additive which comprises at least one of a second anion of larger ionic radius than the first anion, the concentration of the second anion being lower than the concentration of the first anion; and a second cation of larger ionic radius than the first cation, the concentration of the second cation being lower than the concentration of the first cation.

In the discussion of preferred ions and salts that follows it will be appreciated that the salt ionises to provide any of the below mentioned cations and/or anions in the electrolyte but that in accordance with the above first preferred embodiment employing an ionisable additive, the selection of the additive, may also provide any of the below mentioned cations and/or anions, but is subject to the proviso that the ionic radius of anions provided by the additive (the second anions) is larger than the ionic radius of the anions provided by the salt (the first anions) and/or cations provided by the additive (the second cations) is larger than the ionic radius of the cations provided by the salt (the first cations). Thus, only combinations of first and second anions and cations which satisfy this requirement are contemplated by the present invention.

By way of example, a preferred embodiment of the present invention provides an electrolyte comprising an acetonitrile solvent, tetraethylammonium tetrafluoroborate salt and trihexyl(tetradecyl)phosphonium tris(pentafluoroethyl)trifluorophosphate additive, where it will be appreciated that the ionic radius of the trihexyl(tetradecyl)phosphonium cation (1, see below) is larger than the ionic radius of the tetraethylammonium cation (2) and the ionic radius of the tris(pentafluoroethyl)trifluorophosphate anion (3) is larger than the ionic radius of the tetrafluoroborate anion (4).

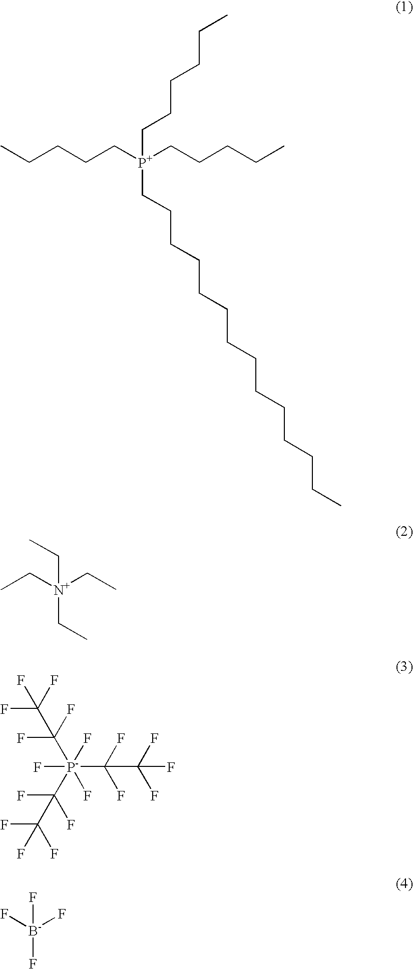

The second cations provided by the additive are preferably selected from the group consisting of substituted or unsubstituted alkylpyrrolidinium ions, substituted or unsubstituted alkylammonium ions, substituted or unsubstituted alkylphosphonium ions, substituted or unsubstituted alkylimidazolium ions and substituted or unsubstituted alkylsulphonium ions. Said alkyl moiety may comprise one or more alkyl groups selected from the group consisting of methyl, ethyl, propyl or butyl. Said alkyl moiety may comprise any combination of different alkyl groups each individually selected from the group consisting of methyl, ethyl, propyl or butyl.

It is particularly preferred that the second cations provided by the additive are selected from the group consisting of 1-butyl-1-methylpyrrolidinium ions, ethyl-dimethyl-propylammonium ions, tetramethylammonium ions, tetraethylammonium ions, tetrabutylammonium ions, trihexyl(tetradecyl)phosphonium ions, 1-butyl-3-methylimidazolium ions, methyl-trioctylammonium ions, ethyl-methyl-imidazolium ions, 1-hexyl-3-methylimidazolium ions and triethylsulphonium ions.

Alternatively, or in addition to the above options for cations provided by the additive in the electrolyte, the additive preferably provides anions selected from the group consisting of substituted or unsubstituted phosphate ions, substituted or unsubstituted sulfonate ions, substituted or unsubstituted borate ions and substituted or unsubstituted imide ions. The anions may be halogenated, and are preferably fluorinated. Said anions preferably contain at least one alkyl group selected from the group consisting of methyl, ethyl, propyl and butyl. The anions may contain any combination of alkyl groups, each alkyl group being individually selected from the group consisting of methyl, ethyl, propyl and butyl. In a preferred embodiment the anions are selected from the group consisting of hexafluorophosphate, tris(pentafluoroethyl)trifluorophosphate, trifluoromethylsulfonate, bis[oxalato(2)]borate, pentafluoroethyltrifluoroborate, bis(trifluoromethylsulfonyl)imide and tetrafluoroborate.

Preferred additive salts are selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate, tetrabutylammonium tetrafluoroborate, tetrabutylammonium hexafluorophosphate, tetraethylammonium tetrafluoroborate and tetraethylammonium hexafluorophosphate, and triethylsulphonium bis(trifluoromethylsulfonyl)imide.

Preferred embodiments of the electrolyte which forms part of the first, second and third aspects of the present invention comprises acetonitrile solvent, a salt selected from the group consisting of tetrabutylammonium tetrafluoroborate, tetrabutylammonium hexafluorophosphate, tetraethylammonium tetrafluoroborate and tetraethylammonium hexafluorophosphate, and an additive in the form of a salt selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate and triethylsulphonium bis(trifluoromethylsulfonyl)imide.

An especially preferred electrolyte comprises acetonitrile solvent, tetraethylammonium tetrafluoroborate salt and trihexyl(tetradecyl)phosphonium tris(pentafluoroethyl)trifluorophosphate additive. Preferably the tetraethylammonium tetrafluoroborate salt is provided in the electrolyte in a concentration of up to about 2 M, more preferably about 1 M, more preferably about 0.75 M. The electrolyte preferably contains about 4 to 10%, more preferably about 6 to 8% trihexyl(tetradecyl)phosphonium tris(pentafluoroethyl)trifluorophosphate additive compared to the concentration of the electrolyte salt. As can be seen from Examples 1 and 2, an electrolyte having the above composition containing the specified additive exhibits significantly improved performance over an electrolyte of the same general composition but which does not include the additive.

In a second preferred embodiment of the electrolyte forming the first aspect of the present invention the additive is a non-ionisable compound which is different to the solvent. As can be seen from Examples 3 and 4, an electrolyte having this composition exhibits significantly improved performance over an electrolyte of the same general composition but which does not include the additive.

In the second preferred embodiment the additive is selected from the group consisting of acetonitrile, γ-butyrolactone, N-butyronitrile, proprionitrile, valeronitrile and a halogenated or unhalogenated alkyl carbonate compound. Preferably the alkyl carbonate compound is selected from the group consisting of ethylene carbonate, propylene carbonate, butylene carbonate, ethylmethylene carbonate and ethylpropylene carbonate. The halogenated alkyl carbonate compound may be substituted with one or more halide ions selected from the group consisting of fluoride, chloride and iodide. It is particularly preferred that the halogenated alkyl carbonate compound is selected from the group consisting of ethyl-2,2,2-trifluoroethyl carbonate, ethyl-2,2,3,3,3-pentafluoroethyl carbonate and ethyl-2,2,3,3-trifluoroethyl carbonate.

Preferred embodiments of the electrolyte employing a non-ionisable additive provide an electrolyte comprising solvent selected from the group consisting of acetonitrile, γ-butyrolactone, N-butyronitrile, proprionitrile, valeronitrile and a halogenated or unhalogenated alkyl carbonate compound, a salt selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate and triethylsulphonium bis(trifluoromethylsulfonyl)imide, and an additive selected from the group consisting of acetonitrile, γ-butyrolactone, N-butyronitrile, proprionitrile, valeronitrile and a halogenated or unhalogenated alkyl carbonate compound subject to the proviso that the additive is different to the solvent.

A first particularly preferred electrolyte comprises propylene carbonate solvent, trihexyl(tetradecyl)phosphonium tris(pentafluoroethyl)trifluorophosphate salt and ethyl-2,2,3,3,3-pentafluoroethyl carbonate additive. A second preferred electrolyte comprises ethyl-2,2,3,3,3-pentafluoroethyl carbonate solvent, trihexyl(tetradecyl)phosphonium tris(pentafluoroethyl)trifluorophosphate salt and propylene carbonate additive.

The salt contained in the electrolyte preferably ionises to provide cations selected from the group consisting of substituted or unsubstituted alkylpyrrolidinium ions, substituted or unsubstituted alkylammonium ions, substituted or unsubstituted alkylphosphonium ions, substituted or unsubstituted alkylimidazolium ions and substituted or unsubstituted sulphonium ions. Said alkyl moiety may comprise one or more alkyl groups selected from the group consisting of methyl, ethyl, propyl or butyl. Said alkyl moiety may comprise any combination of different alkyl groups each individually selected from the group consisting of methyl, ethyl, propyl or butyl.

It is particularly preferred that the electrolyte salt ionises to provide cations selected from the group consisting of 1-butyl-1-methylpyrrolidinium ions, ethyl-dimethyl-propylammonium ions, tetramethylammonium ions, tetraethylammonium ions, tetrabutylammonium ions, trihexyl(tetradecyl)phosphonium ions, 1-butyl-3-methylimidazolium ions, methyl-trioctylammonium ions, ethyl-methyl-imidazolium ions, 1-hexyl-3-methylimidazolium ions and triethylsulphonium ions.

Alternatively, or in addition to the above options for cations provided by the salt in the electrolyte, the salt preferably ionises to provide anions selected from the group consisting of substituted or unsubstituted phosphate ions, substituted or unsubstituted sulfonate ions, substituted or unsubstituted borate ions and substituted or unsubstituted imide ions. The anions may be halogenated, and are preferably fluorinated. Said anions preferably contain at least one alkyl group selected from the group consisting of methyl, ethyl, propyl and butyl. The anions may contain any combination of alkyl groups, each alkyl group being individually selected from the group consisting of methyl, ethyl, propyl and butyl. In a preferred embodiment the anions are selected from the group consisting of hexafluorophosphate, tris(pentafluoroethyl)trifluorophosphate, trifluoromethylsulfonate, bis[oxalato(2)]borate, pentafluoroethyltrifluoroborate, bis(trifluoromethylsulfonyl)imide and tetrafluoroborate.

Preferred salts are selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate, tetrabutylammonium tetrafluoroborate, tetrabutylammonium hexafluorophosphate, tetraethylammonium tetrafluoroborate, tetraethylammonium hexafluorophosphate and triethylsulphonium bis(trifluoromethylsulfonyl)imide.

It is preferred that the solvent contained in the electrolyte of the first aspect of the present invention is an organic solvent, and is preferably selected from the group consisting of acetonitrile, γ-butyrolactone, N-butyronitrile, proprionitrile, valeronitrile and a halogenated or unhalogenated alkyl carbonate compound. Any of the aforementioned organic solvents may be used in the electrolyte individually or in any desirable combination. The alkyl carbonate compound may be selected from the group consisting of ethylene carbonate, propylene carbonate, butylene carbonate, ethylmethylene carbonate and ethylpropylene carbonate. The halogenated alkyl carbonate compound may be substituted with one or more halide ions selected from the group consisting of fluoride, chloride and iodide. The halogenated alkyl carbonate compound is preferably selected from the group consisting of ethyl-2,2,2-trifluoroethyl carbonate, ethyl-2,2,3,3,3-pentafluoroethyl carbonate and ethyl-2,2,3,3-trifluoroethyl carbonate.

The electrolyte may further comprise a co-solvent selected from the group consisting of dimethyl sulfoxide, butyl methyl sulfoxide, dimethyl formamide, N-methyl-2-pyrrolidine, N-butyl-2-pyrrolidone, dimethyl acetamide and sulfolane.

As mentioned above, the third aspect of the invention provides a method for optimising an electrolyte for use in a capacitor.

Preferably, the plurality of different combinations of different combinations of applied voltage and electrolyte compositions at which the potential differences are measured comprises at least two different applied voltages at each of at least two different electrolyte compositions. The plurality of different combinations of different combinations of applied voltage and electrolyte compositions preferably comprises at least a first applied voltage in combination with a first electrolyte composition; the first applied voltage in combination with a second electrolyte composition; a second applied voltage in combination with the first electrolyte composition; and the second applied voltage in combination the said second electrolyte composition.

In certain embodiments the applied voltage may be varied continuously while potential difference measurements are taken. For example, an electrolyte composition may be chosen, and the voltage applied between the test anode and cathode scanned through a range of values. Subsequently, a different electrolyte composition may be chosen, and the applied voltage again scanned through a range. In this way, measurements indicative of how the potentials of each electrode relative to the electrolyte vary with magnitude of applied voltage and electrolyte compositions may be built up.

In alternative embodiments, the steps of applying a voltage and varying the applied voltage comprise applying a plurality of different discrete voltages between the test anode and test cathode. In such embodiments, each of the plurality of different discrete voltages may be applied in combination with each of a plurality of different discrete electrolyte compositions, and the potential differences measured for each combination.

Preferably, each of the plurality of different discrete voltages is less than or equal to a theoretical maximum operational voltage window, defined by the positive and negative voltage breakdown limits.

In certain embodiments, the step of using the measurements to select an electrolyte composition comprises comparing the measured potential differences with the positive and negative voltage breakdown limits.

Preferably, the selected electrolyte composition is the composition at which the largest voltage can be applied between the test anode and test cathode with the potential difference between the test anode and test cathode and the electrolyte not exceeding the respective anode and cathode voltage breakdown limit.

Preferably, the method further comprises the step of plotting the measurements on a graph to illustrate variation of the potential differences with applied voltage and electrolyte composition. The method may further comprise plotting the voltage breakdown limits for the anode and cathode on the graph, which provides a convenient way of visually identifying the electrolyte composition that provides the maximum operating voltage window.

In a preferred embodiment, the step of determining a positive voltage breakdown limit for the selected anode structure and electrolyte comprises using a cyclic voltammetry technique. Similarly, in a further preferred embodiment a cyclic voltammetry technique may be used to determine the negative voltage breakdown limit.

The potential differences are preferably measured in such a way that they accurately represent potentials between the respective electrode and the bulk electrolyte. This can be achieved by arranging a further test electrode in contact with the electrolyte at a position far enough away from the test anode and test cathode to be outside the electrochemical double layers.

Throughout the present application the following abbreviations will be used to describe electrolyte solvents and salts.

### Electrolyte Solvents

AN=acetonitrile
BL=γ-butyrolactone
PC=propylene carbonate
ETFEC=ethyl-2,2,2-trifluoroethyl carbonate
ETFPC=ethyl-2,2,3,3-tetrafluoropropyl carbonate
EPFPC=ethyl-2,2,3,3,3-pentafluoropropyl carbonate

### Electrolyte Salts/Additives

M 1=1-Butyl-1-methylpyrrolidinium tris(pentafluoroethyl) trifluorophosphate
M 2=Ethyl-dimethyl-propylammonium bis(trifluoromethylsulfonyl)imide
M 3=1-Butyl-1-methyl-pyrrolidinium trifluoromethylsulfonate
M 4=Trihexyl(tetradecyl)phosphonium tris(pentafluoroethyl)trifluorophosphate
M 5=1-Butyl-1-methylpyrrolidinium bis[oxalato(2)]borate
M 6=Butyl-methyl-pyrrolidine ethyloctafluoroborate
M 7=Tetraethyl ammonium ethyloctafluoroborate
M 8=Tetramethylammonium ethyloctafluoroborate
M 9=Trihexyl(tetradecyl)phosphonium bis[oxalato(2)]borate
M 10=1-Butyl-3-methylimidazolium hexafluorophosphate
M 11=1-Butyl-3-methylimidazolium tetrafluoroborate
TBABF4=Tetrabutyl ammonium tetrafluoroborate
TBAPF6=Tetrabutyl ammonium hexafluorophosphate
TEABF4=Tetraethyl ammonium tetrafluoroborate
TEAPF6=Tetraethyl ammonium hexafluorophosphate
SI1=Triethyl sulphonium bis(trifluoromethylsulfonyl)imide

Where a solvent is suffixed with a number, e.g. AN/0.75M, the number corresponds to the molar concentration of the salt dissolved in the solvent. For example, ‘AN/0.75M TBABF4’ represents an electrolyte consisting of 0.75 M tetrabutylammonium tetrafluoroborate dissolved in acetonitrile.

Embodiments of the invention will now be described with reference to the accompanying drawings, of which:

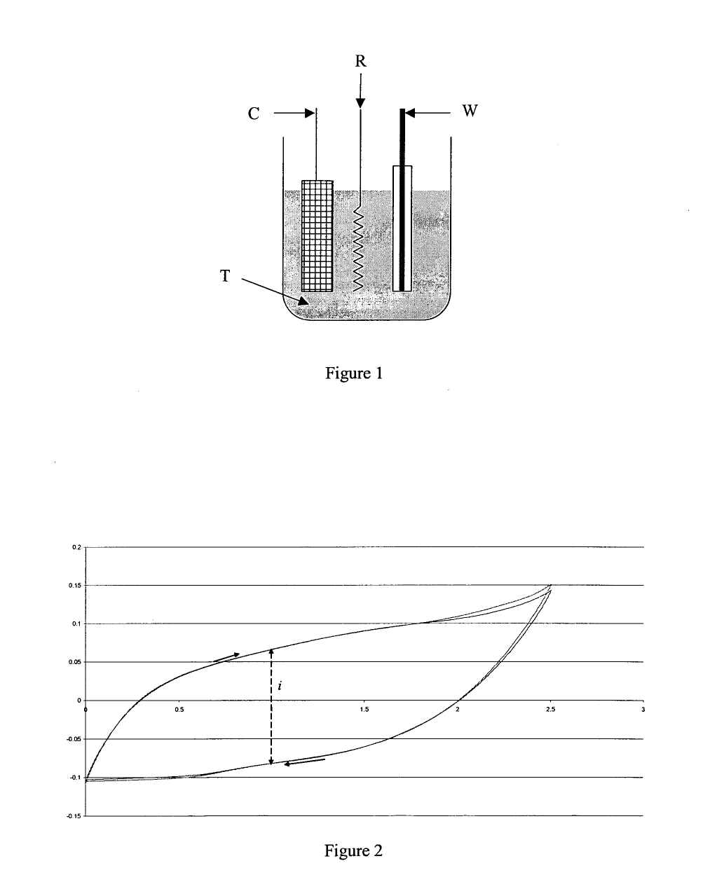

FIG. 1 is a schematic representation of apparatus used in methods embodying the invention to generate a cyclic voltammogram (CV);

FIG. 2 is a CV generated using the apparatus of FIG. 1;

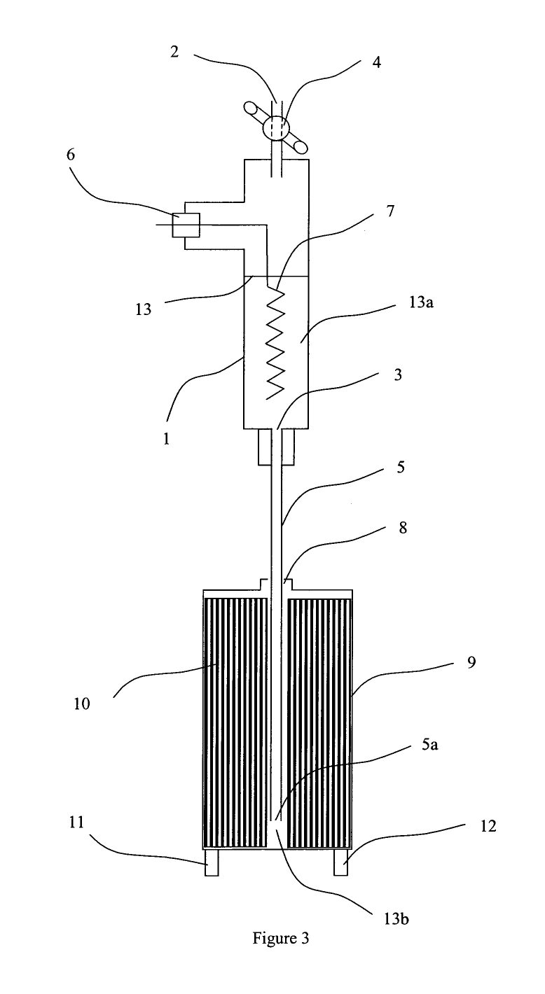

FIG. 3 is a schematic representation of apparatus for measuring the electrical potential of an electrolyte according to an embodiment of the present invention contained in a capacitor;

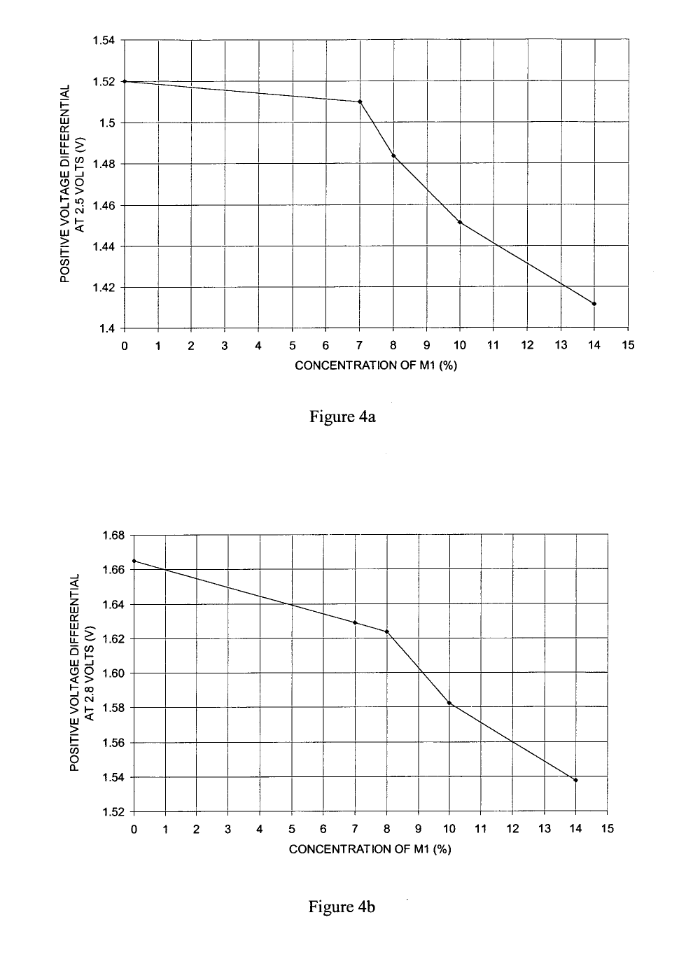

FIGS. 4a and 4b are graphs showing results obtained using the apparatus of FIG. 3 to test an electrolyte according to an embodiment of the present invention contained in a capacitor, said electrolyte comprising an AN solvent with an M1 additive;

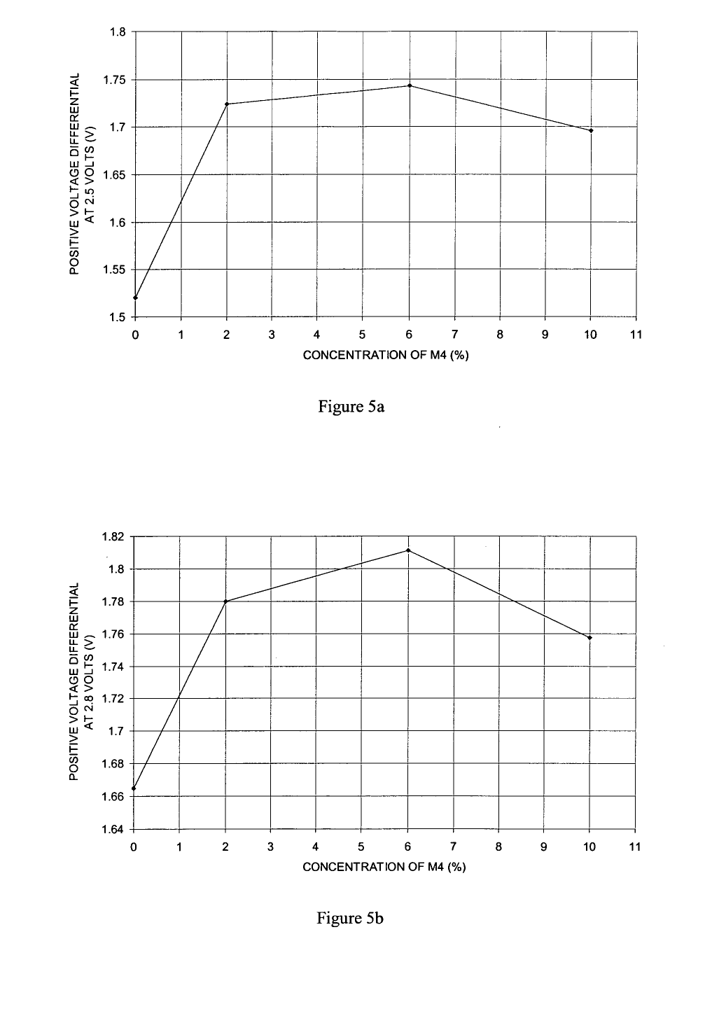

FIGS. 5a and 5b are graphs showing results obtained using the apparatus of FIG. 3 to test an electrolyte according to an embodiment of the present invention contained in a capacitor, said electrolyte comprising an AN solvent with an M4 additive;

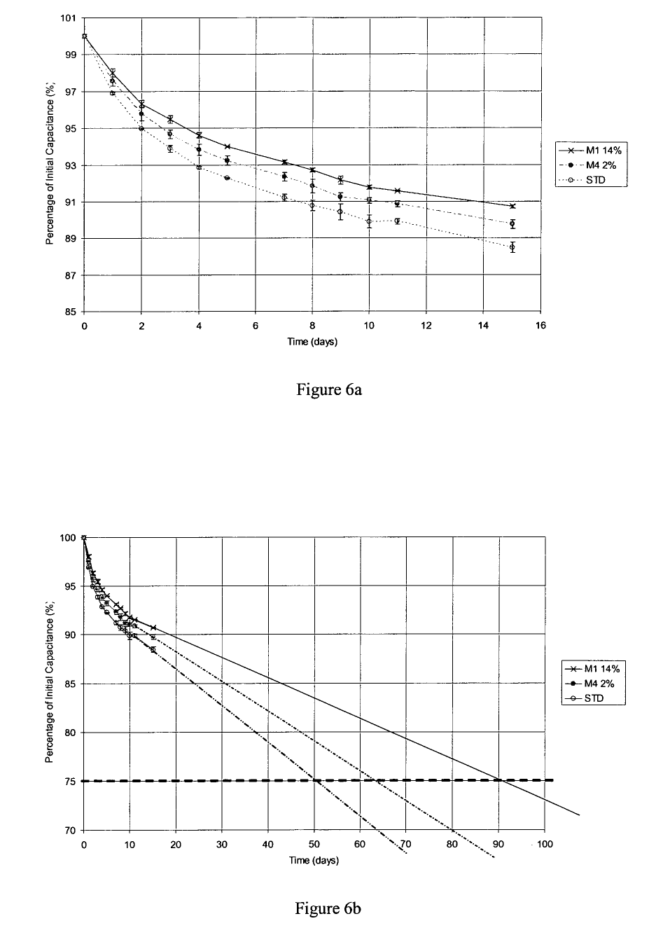

FIGS. 6a and 6b are graphs showing results obtained using the apparatus of FIG. 3 employing a standard electrolyte and two electrolytes according to embodiments of the present invention comprising an AN solvent with an M1 and M4 additive respectively;

FIG. 7 is a graph showing how different additives affect the capacitance of capacitors incorporating electrolytes according to preferred embodiments of the present invention; and

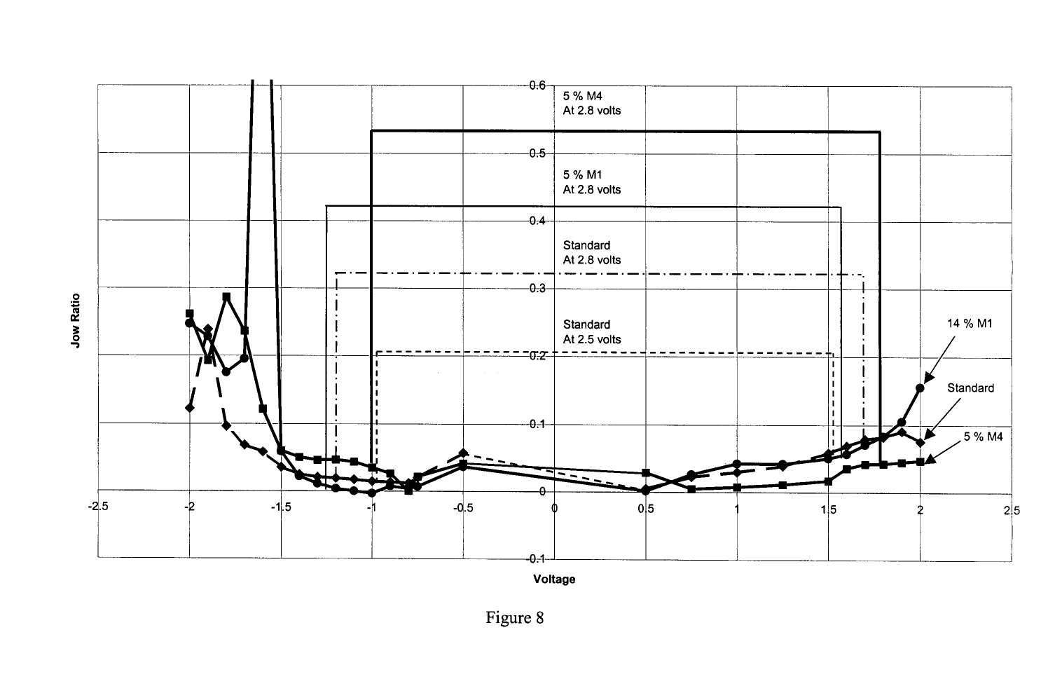

FIG. 8 is a graph showing the results of a Jow et al. analysis (Xu, Ding & Jow; Electrochimica Acta, 46, 2001, 1823-1827) of three commercially available capacitors, a first capacitor incorporating a standard commercially available electrolyte, and second and third capacitors incorporating electrolytes according to preferred embodiments of the present invention.

An embodiment of the invention provides a method of optimising an electrochemical capacitor. It can also be considered to be a method of optimising the operating voltage of a capacitor. The method can be regarded as a two-stage method, the two stages being as follows.

Stage 1—Determine the voltage breakdown limits of the specific electrolyte composition in combination with the electrode material by cyclic voltammetry.

This technique involves the linear scanning of the potential of a test or working electrode, W, between set potential limits relative to a reference electrode, R. The resulting plot of current against potential is termed a cyclic voltammogram or CV.

FIG. 1 is a schematic representation of a typical cell utilized in the generation of a CV.

The working electrode, W, was the material under test (in this case a silicon carbide powder anode or positive electrode material) in a test electrolyte, T. The null current reference electrode, R, was a silver wire coil and the potential of the working electrode, W, is altered relative to this silver wire. The third electrode is the counter electrode, C, (in this case composed of titanium nitride). The potential of the counter electrode, C, was automatically adjusted so as to support the current flow at the working electrode, W. Potential control and data collection was achieved using an Autolab PGSTAT100 electrochemical work station. The CV generated for the silicon carbide anode/titanium nitride counter electrode system is shown in FIG. 2.

The charge on the electrode (Q) is proportional to the voltage drop across the system (E):

Q=CE

The proportionality constant C is the capacitance of the electrode/electrolyte system. Thus, on application of a potential, charge is stored i.e. a charging current is observed. In order to calculate the charging current the above equation is differentiated with respect to time (t) assuming the capacitance is constant to give

$$\frac{d Q}{d t} = C \frac{d E}{d t}$$

The term dQ/dt is a term for the charging current (i) and dE/dt is the potential scan rate (v). As such, the capacitance of the electrode system shown in FIG. 2 can be calculated as:

i=Cv

As i=0.148 A and the potential scan rate was 10 mVs⁻¹ the capacitance can be calculated as 14.80 F. The powder electrode was constructed using 1.044 g of silicon carbide and so the capacitance is 14.17 Fg⁻¹.

The CV provides several important pieces information about the electrolyte system, including the maximum voltage the system will stand (sometime referred to as the ‘withstanding voltage’), and whether the electrode and electrolyte are interacting undesirably below the maximum operating voltage.

The first desirable feature of a CV for a capacitor system of interest is an unreactive area up to the point of breakdown. This is because any reaction will degrade the electrode and/or electrolyte which will shorten the life of the capacitor and cause the capacitor to lose charge quickly.

The second desirable feature is a high electrolyte breakdown point which indicates that a high operating voltage should be achievable with appropriate selection of electrode materials and surface areas.

CVs are obtained separately for the positive and negative electrodes. The maximum positive and negative operating voltages are then derived from the CVs to ensure that the capacitor will function satisfactorily over an acceptable lifetime. In practice the breakdown voltages are taken as just below the actual breakdown point to allow a margin of safety. The positive and negative breakdown voltages are then added together to provide the maximum theoretical operational voltage window for a particular electrode/electrolyte system.

Stage 2—Measuring voltage differences for each electrode relative to the electrolyte solution.

It is generally believed that in a charged electrochemical capacitor when the system is balanced and stable the charge on one electrode equals the charge on the other electrode. For example, considering a capacitor incorporating two identical graphite electrodes and an organic electrolyte composed of acetonitrile and tetrabutylammonium hexafluorophosphate, at an applied voltage of 3 volts it would be expected that the voltage of each electrode relative to the solution is 1.5 volts. However, the inventor has surprisingly found that this is generally not the case.

The inventors have determined that in the above example the voltage difference between the positive electrode and the solution is 2.25 volts and the voltage difference between the negative electrode and the solution 0.85 volts. Other examples employing an applied voltage of approximately 3 volts and using equal surface area glassy carbon electrodes are shown in Table 1 below.

TABLE 1

| ELECTROLYTE | +ΔV | −ΔV |
|---|---|---|
| TEABF4 (0.75M) AN | 1.33 | 1.67 |
| TEABF4 + M4 2.5% (0.75M total) AN | 1.37 | 1.63 |
| TEABF4 + M4 5.0% (0.75M total) AN | 1.43 | 1.57 |
| TEABF4 + M4 7.5% (0.75M total) AN | 1.44 | 1.56 |
| TEABF4 + M4 10.0% (0.75M total) AN | 1.44 | 1.56 |
| TEABF4 + M4 15.0% (0.75M total) AN | 1.49 | 1.51 |
| TEABF4 + M4 20.0% (0.75M total) AN | 1.47 | 1.53 |
| TEABF4 + M4 25.0% (0.75M total) AN | 1.68 | 1.32 |
| M4 (0.5M) PC | 1.65 | 1.35 |
| M4 (0.5M) PC + 2.0% EPFPC (v/v) | 1.75 | 1.25 |
| M4 (0.5M) PC + 4.0% EPFPC (v/v) | 1.75 | 1.25 |
| M4 (0.5M) PC + 6.0% EPFPC (v/v) | 1.80 | 1.20 |
| M4 (0.5M) PC + 8.0% EPFPC (v/v) | 1.81 | 1.19 |
| M4 (0.5M) PC + 10.0% EPFPC (v/v) | 1.82 | 1.18 |
| M4 (0.5M) EPFPC | 1.43 | 1.57 |
| M4 (0.5M) EPFPC) + 2.0% PC (v/v) | 1.50 | 1.50 |
| M4 (0.5M) EPFPC) + 4.0% PC (v/v) | 1.49 | 1.51 |
| M4 (0.5M) EPFPC) + 6.0% PC (v/v) | 1.56 | 1.44 |
| M4 (0.5M) EPFPC) + 8.0% PC (v/v) | 1.59 | 1.41 |
| M4 (0.5M) EPFPC) + 10.0% PC (v/v) | 1.60 | 1.40 |
| M6 (0.75M) AN | 1.56 | 1.44 |
| M6 (0.75M) PC | 1.25 | 1.75 |

While the inventors do not wish to be bound by any specific theory it is believed that the non-equal voltage differences observed for the positive and negative electrodes relative to the electrolyte solution may be related, at least in part, to the nature of the double layer formed at the surface of the electrode when a voltage is applied to the capacitor system. However, as described above, the double layer composed of solvated ions and solvent molecules is complicated and many factors affect the nature and thickness of these layers.

With regard to the optimisation of electrolytes and capacitor systems in accordance with the present invention the voltage of each electrode relative to the electrolyte solution is measured for a first electrolyte solution whilst maintaining a steady voltage across the electrodes. This process is repeated the appropriate number of times to determine the maximum applied voltage which is as close as possible to the theoretical maximum operational voltage determined above using cyclic voltammetry in Stage 1 of the process.

The above procedure is then repeated for each of a series of different electrolyte compositions with varying amounts of additive until the maximum possible operational voltage window is determined. Where two different electrolyte solutions provide the same maximum operational voltage window the optimum solution can be chosen based on the electrolyte which contains the lower amount of additive (i.e. determined using cost constraints) or the electrolyte which produces the most acceptable cyclic voltamogram. The third aspect of the present invention therefore provides a simple and accurate method of determining the optimum electrolyte composition to maximize the working voltage for a particular capacitor system which necessarily takes in to account the complex effects of changes within the double layer as a result of voltage variations.

The use of glassy carbon to measure differential voltage is a convenient tool to produce a large number of repeatable results. The carbon is non-porous and so both electrodes have an identical surface area to each other; this is critical when seeking to obtain good results because even small variations in surface area between the electrodes causes a shift in the differential voltage. Glassy carbon electrodes were therefore used in Examples 1, 3 and 4 to test the performance of electrolytes according to preferred embodiments of the present invention against standard electrolytes. The results presented below indicate that additives affect the positive and/or negative voltage differentials for capacitor systems. Additives can therefore be used to modify a voltage differential between an electrode and an electrolyte so that it more closely matches the predetermined voltage breakdown limit for that electrode/electrolyte pair. In this way, a higher operational voltage window can be accessed for any given capacitor, thereby increasing the energy storage capacity of the capacitor.

While any appropriate amount of additive may be employed, it is desired that the amount of the additive compared to the amount of the electrolyte salt should be up to around 50%, more preferably up to around 30% for various reasons, including economic viability.

The behaviour of a capacitor from the point of view of the voltage differential depends on the nature of the electrolyte and the nature of the electrodes, most importantly the relative area of the two electrodes. The electrolyte and the relative areas of the electrodes act in concert to produce a specific differential which is specific to that particular capacitor.

Commercially available capacitors tend to have very reproducible positive and negative differential voltages. By using the apparatus described below with reference to FIG. 3 the inventors have determined that the positive and negative differential voltages of working commercial capacitors react to the presence of an additive in the same way as test capacitors employing glassy carbon electrodes. This self-consistency is important because it validates the testing methods employing glassy carbon electrodes (Examples 1, 3 and 4), the in-capacitor results (Examples 6, 7, 8 and 10) and the testing apparatus depicted in FIG. 3.

To further investigate the performance of electrolytes according to preferred embodiments of the present invention actual pieces of commercial capacitor electrodes are tested using the method developed by Jow et al. (Xu, Ding & Jow; Electrochimica Acta, 46, 2001, 1823-1827).

The Jow et al. method (Xu, Ding & Jow; Electrochimica Acta, 46, 2001, 1823-1827) enables plots of the electrochemical activity of an electrode to be generated which highlight the electrochemical activity of an electrode in a particular electrolyte. This is normally very difficult because the charging effects of the high surface area carbon electrode material normally masks the electrochemistry of the electrode in the electrolyte. However, by comparing a measured positive charge current to a measured negative charge current it is possible to focus on the electrochemical activity of the electrode. If no electrochemistry is taking place, the positive charge current and the negative charge current are substantially equal. If there is a significant amount of electrochemistry taking place when the voltage is applied then a disparity between the positive and negative readings will be detected. For example, a reading of 0.1 signifies that 10% of the charging current is being used to drive electrochemistry. The lower this value the less electrochemistry is taking place.

In order to further test the performance of electrolytes according to preferred embodiments of the present invention in working capacitors the apparatus shown schematically in FIG. 3 was developed, which is currently the subject of a co-pending UK patent application. Results for electrolytes according to embodiments of the present invention obtained using the apparatus of FIG. 3 are set out below in Examples 6 to 8.

FIG. 3 depicts apparatus for measuring the electrical potential of an electrolyte contained in a capacitor. FIG. 3 shows a reservoir 1. The reservoir 1 is provided with an inlet port 2 and an outlet port 3. The inlet port 2 can be opened and closed using a tap 4. The outlet port 3 opens into a conduit 5. The conduit 5 is tube-shaped (e.g. a capillary tube or the like) and is provided with an opening 5a remote from the reservoir 1. The reservoir 1 is also provided with a sealed opening 6. A reference electrode 7 is located in the reservoir 1, and electrical connection to the reference electrode 7 is made via the sealed opening 6.

The reservoir 1 and conduit 5 may be separate bodies connected to one another, or may be formed integrally. Preferably the conduit 5 and the reservoir 1 are formed from materials so as to not conduct electricity, the significance of which will be described in more detail below. For example, the conduit 5 and/or the reservoir 1 may be formed from glass, plastic, or any other electrical insulator.

The sealed opening 6 and inlet port 2, when the tap 4 is closed are substantially air tight, so that no fluid within the reservoir 1 can evaporate away.

It can be seen from FIG. 3 that the conduit 5 extends into a capacitor 9. The capacitor 9 is a cylindrical capacitor 9 provided with cylindrically shaped plates 10. The capacitor is a Maxwell 350F capacitor. The capacitor 9 is also provided with a first electrode 11 and a second electrode 12, via which electrical connection to the capacitor 9 can be made.

If the capacitor 9 needs to be dried of electrolyte, it can be dried in any one of a number of ways. One example of how the capacitor 9 may be dried of electrolyte is now given. The capacitor 9 may be dried under vacuum at 100° C. for 48 hours in a desiccator oven. The capacitor 9 may be removed from the desiccator oven by back filling the oven with argon, prior to opening the oven. Once the oven is opened, the capacitor 9 is sealed to ensure that the plates 10 of the capacitor 9 are kept under a dry argon atmosphere. The capacitor 9 is then allowed to cool.

Once the capacitor 9 has cooled, it is filled with electrolyte. The capacitor 9 is filled with electrolyte using the reservoir 1 and conduit 5 shown in FIG. 3. Firstly, the conduit 5 is passed through the opening 8 of the capacitor 9 such that the conduit opening 5a is located within the capacitor 9. The tap 4 is opened to allow electrolyte 13 to be passed through the inlet port 2 and into the reservoir 1. The electrolyte 13 flows down and through the conduit 5 and into the capacitor 9. The filling of the capacitor 9 with electrolyte 13 is performed in a number of steps to ensure that the material forming the plates 10 is fully wetted. Initially, the capacitor is filled up to the level of the opening 8. Due to the nature of the material forming the plate 10, the electrolyte 13 slowly wicks into the plates (due to the porous structure of, for example, carbon which forms the plates 10), and hence the level of the electrolyte 13 needs to be periodically topped up until no more electrolyte is required. This process may take around eight hours. Once the level of the electrolyte 13 has stabilised, more electrolyte 13 is passed through the inlet port 2 and into the reservoir 1 such that the referenced electrode 7 is immersed in the electrolyte 13. The tap 4 is then closed such that no more electrolyte 13 may pass into the reservoir 1 and capacitor 9. Electrolyte 13 cannot evaporate from the reservoir 1 and through the inlet port 2, because the tap 4 is closed. Any gaps around the conduit 5 in the vicinity of the opening 8 of the capacitor 9 maybe sealed with, for example, pliable putty or the like, such that no electrolyte 13 can evaporate from the capacitor 9.

The plates 10 of the capacitor 9 have a very large surface area. As a consequence of the large surface area of the plates 10, a conditioning period is required prior to undertaking any tasks on the capacitor 9. The conditioning period involves the application of a voltage between the plates 10 of the capacitor 9 (via the first electrode 11 and second electrode 12) for a prolonged period of time, say at least about one hour to forty eight hours depending on the size of the capacitor, prior to the taking of any measurements associated with the operation of the capacitor 9. For example, a voltage of 2.5V may be applied between the first electrode 11 and second electrode 12 prior to the measurement of any electrical properties of the capacitor 9.

The electrolyte 13 is electrically conductive. Consequently, even though the reference electrode 7 is located in a first portion of the electrolyte 13a located outside of the capacitor 9, the reference electrode 7 is still in electrical connection with a second portion of the electrolyte 13b located inside of the capacitor 9. This means that the electrical potential of the second portion of the electrolyte 13b located inside of the capacitor can be measure in-situ, e.g. in a working capacitor.

The capacitor 9 may be tested in any appropriate way once the conditioning period is completed. When the conditioning voltage of 2.5V is applied between the plates 10 of the capacitor 9, the electrical potential of the electrolyte 13 relative to a positive electrode (for example, the second electrode 12) is then measured to determine the positive voltage differential. This may be achieved by measuring the electrical potential difference between the reference electrode 7 and the second electrode 12 using, for example, a digital voltmeter (not shown). Alternatively, the electrical potential of the electrolyte 13 relative to a negative electrode (for example, the first electrode 11) maybe measured to determine the negative voltage differential. This may be achieved by measuring the electrical potential difference between the reference electrode 7 and the first electrode 11 using, for example, a digital voltmeter (not shown).

A measurement of the electrical potential may be undertaken every five, ten, fifteen, or twenty minutes. A stable electrical potential is determined when the measured electrical potential is the same over, for example, two or three consecutive measurements. The overall test time at a particular test voltage maybe around ninety minutes.

The positive voltage differential may be determined for any electrical potential difference applied between the first electrode 11 and second electrode 12. If a different voltage is to be applied between the first electrode 11 and second electrode 12, the conditioning period mentioned above should be undertaken at the different test voltage prior to the determination of the positive (or indeed negative) voltage differentials. For example, the positive voltage differential may be measured when a voltage of 2.5V is applied across the first electrode 11 and second electrode 12, and then 2.6V, 2.7V, 2.8V, 2.9V, and 3V. This process, or a similar process, can be undertaken for different electrolytes, for example, electrolytes having different levels of additives. Examples of electrolytes, and results obtained using those electrolytes are given below.

The apparatus of FIG. 3 was used to test electrolytes according to preferred embodiments of the present invention, as described in more detail in Examples 6, 7 and 8.

The differences in the results obtained for different voltages applied between the plates 10 of the capacitor 9 can be used to infer information about the behaviour of the electrolyte 13 and/or the capacitor 9 as a whole. For example, the results obtained for different applied voltages and additive concentrations can be used to choose a suitable additive for use in an electrolyte to optimise the performance (e.g. operating voltage) of a capacitor. To this end, it will be appreciated that the ability to modify (i.e. increase or decrease) the positive and/or negative voltage differentials of the electrolyte enables the working voltage of the capacitor to be increased. Since the working voltage of the capacitor may be increased, so may the charge which the capacitor can store.

The apparatus described above has a reservoir 1 and a conduit 5 extending from the reservoir 1. This is not essential, and the reservoir 1 could be shaped to come to a point or to form a thin channel (e.g. to form a conduit) which could be inserted into any appropriate opening in the capacitor 9. The overriding function of the apparatus shown in FIG. 3 is to measure the electrical potential of the electrolyte in the (working) capacitor 9 without having to deconstruct or modify the capacitor 9. That is, a portion of the electrolyte outside of the capacitor 9 in which is located the reference electrode 7 is used to conduct the electrical potential of the portion of the electrolyte within the capacitor to the reference electrode 7.

The capacitor of FIG. 3 was described as being filled from a reservoir in which a reference electrode was located. This is not essential. The capacitor of FIG. 3 could be filled from any suitable reservoir and in any suitable manner, for example following the filling steps mentioned above. The conduit of the apparatus of FIG. 3 could then be inserted into the capacitor, and the reservoir filled with electrolyte to immerse the reference electrode and bring the reference electrode into electrical connection with electrolyte located in the capacitor.

An alternative arrangement to that shown in FIG. 3 would be where a capacitor is fully or partially immersed in a reservoir of electrolyte, with a reference electrode being located in the electrolyte in the reservoir, but external to the capacitor. The reference electrode is still then in electrical connection with electrolyte located in the capacitor but the reference electrode does not need to be placed inside the capacitor to measure the electrical potential of the electrolyte. Although such a measurement technique and apparatus is possible, it may be more practical to undertake measurements using the apparatus described in relation to FIG. 3. This is because it may be undesirable or impractical to fully or partially immerse the capacitor in the electrolyte.

Although the method and apparatus described above in relation to FIG. 3 have made reference to certain electrolyte solvents and electrolytes additives in accordance with preferred embodiments of the present invention, it will be appreciated that the apparatus as described is equally applicable to other electrolytes.

In the embodiments mentioned above, the measurements of the potential of an electrolyte have been described in relation to a specific capacitor. However, the invention is not limited to the use of this specific capacitor, and the invention may be used to measure the potential of electrolyte contained in any capacitor. The capacitor to be tested may already be provided with an opening for insertion of, for example, a conduit. Alternatively, an opening may be made in the capacitor.

Further embodiments of the invention will now be described by way of example only with reference to the following non-limiting Examples.

### EXAMPLES

### Example 1

Three capacitor systems were constructed which consisted of glassy carbon electrodes and an electrolyte solution containing AN and TEABF4 (0.75 M). The first capacitor system employed an electrolyte containing just AN and TEABF4 with no additive. The second capacitor system employed an electrolyte solution containing 4% M4 additive (relative to the amount of TEABF4) and the third system employed an electrolyte containing 10% M4.

The electrolyte breakdown limit was determined using the above described CV method for each capacitor system. A series of voltages was then applied across each capacitor system and the individual positive and negative electrode voltage differentials relative to the electrolyte determined as described above. The results obtained are set out below in tables 2, 3 and 4.

The maximum voltage window for each capacitor system (shown in table 5) was determined by comparing the measured individual positive and negative electrode voltage differentials to the respective positive and negative electrode electrolyte breakdown limits. Taking the results presented in table 1 for example, the maximum applied voltage at which both the positive and negative electrode voltage differentials are less than their respective positive and negative electrode electrolyte breakdown values is 3.65 v. At 3.70 v applied voltage, while the positive electrode differential (1.64 v) is still below the positive electrode electrolyte breakdown limit (2.10 v), the negative electrode voltage differential (2.06 v) exceeds the negative electrode electrolyte breakdown limit (2.05 v).

TABLE 2

| | POSITIVE | NEGATIVE |
|---|---|---|
| 0% M4 ADDITIVE | ELECTRODE/v | ELECTRODE/v |
| ELECTROLYTE | 2.10 | 2.05 |
| BREAKDOWN LIMIT | | |
| APPLIED VOLTAGE/v | | |
| 3.00 | 1.33 | 1.67 |
| 3.50 | 1.55 | 1.95 |
| 3.55 | 1.57 | 1.98 |
| 3.60 | 1.60 | 2.00 |
| 3.65 | 1.62 | 2.03 |
| 3.70 | 1.64 | 2.06 |
| 3.75 | 1.66 | 2.09 |
| 3.80 | 1.68 | 2.12 |
| 3.85 | 1.71 | 2.14 |
| 3.90 | 1.73 | 2.17 |
| 3.95 | 1.75 | 2.20 |
| 4.00 | 1.77 | 2.23 |
| 4.05 | 1.80 | 2.25 |
| 4.10 | 1.82 | 2.28 |
| 4.15 | 1.84 | 2.31 |
| 4.20 | 1.86 | 2.34 |
| 4.25 | 1.88 | 2.37 |
| 4.30 | 1.91 | 2.39 |
| 4.35 | 1.93 | 2.42 |
| 4.40 | 1.95 | 2.45 |
| 4.45 | 1.97 | 2.48 |

TABLE 3

| | POSITIVE | NEGATIVE |
|---|---|---|
| 4% M4 ADDITIVE | ELECTRODE/v | ELECTRODE/v |
| ELECTROLYTE | 2.15 | 2.37 |
| BREAKDOWN LIMIT | | |
| APPLIED VOLTAGE/v | | |
| 3.00 | 1.47 | 1.63 |
| 3.50 | 1.72 | 1.90 |
| 3.55 | 1.74 | 1.93 |
| 3.60 | 1.76 | 1.96 |
| 3.65 | 1.79 | 1.98 |
| 3.70 | 1.81 | 2.01 |
| 3.75 | 1.84 | 2.04 |
| 3.80 | 1.86 | 2.06 |
| 3.85 | 1.89 | 2.09 |
| 3.90 | 1.91 | 2.12 |
| 3.95 | 1.94 | 2.15 |
| 4.00 | 1.96 | 2.17 |
| 4.05 | 1.98 | 2.20 |
| 4.10 | 2.01 | 2.23 |
| 4.15 | 2.03 | 2.25 |
| 4.20 | 2.06 | 2.28 |
| 4.25 | 2.08 | 2.31 |
| 4.30 | 2.11 | 2.34 |
| 4.35 | 2.13 | 2.36 |
| 4.40 | 2.16 | 2.39 |
| 4.45 | 2.18 | 2.42 |
| 4.50 | 2.21 | 2.45 |
| 4.55 | 2.23 | 2.47 |
| 4.60 | 2.25 | 2.50 |
| 4.65 | 2.28 | 2.53 |

TABLE 4

| | POSITIVE | NEGATIVE |
|---|---|---|
| 10% M4 ADDITIVE | ELECTRODE/v | ELECTRODE/v |
| ELECTROLYTE | 2.10 | 2.35 |
| BREAKDOWN LIMIT | | |
| APPLIED VOLTAGE/v | | |
| 3.00 | 1.44 | 1.56 |
| 3.50 | 1.68 | 1.82 |
| 3.55 | 1.70 | 1.85 |
| 3.60 | 1.73 | 1.87 |
| 3.65 | 1.75 | 1.90 |
| 3.70 | 1.78 | 1.92 |
| 3.75 | 1.80 | 1.95 |
| 3.80 | 1.82 | 1.98 |
| 3.85 | 1.85 | 2.00 |
| 3.90 | 1.87 | 2.03 |
| 3.95 | 1.90 | 2.05 |
| 4.00 | 1.92 | 2.08 |
| 4.05 | 1.94 | 2.11 |
| 4.10 | 1.97 | 2.13 |
| 4.15 | 1.99 | 2.16 |
| 4.20 | 2.02 | 2.18 |
| 4.25 | 2.04 | 2.21 |
| 4.30 | 2.06 | 2.24 |
| 4.35 | 2.09 | 2.26 |
| 4.40 | 2.11 | 2.29 |
| 4.45 | 2.14 | 2.31 |
| 4.50 | 2.16 | 2.34 |
| 4.55 | 2.18 | 2.37 |
| 4.60 | 2.21 | 2.39 |
| 4.65 | 2.23 | 2.42 |

TABLE 5

| | MAXIMUM VOLTAGE | |
|---|---|---|
| | WINDOW/ | ENERGY STORAGE |
| AMOUNT M4/% | volts | INCREASE/% |
| 0 | 3.65 | 0 |
| 4 | 4.35 | 42 |
| 10 | 4.35 | 42 |

As can be seen from table 5, the addition to the electrolyte of a small amount of M4 had a significant effect on the capacity of the positive and negative electrodes, and increased the energy storage capacity of the capacitor system by 42%.

### Example 2

For comparison with the results presented in Example 1, a commercially available capacitor was purchased (EPCOS 110 F 2.5 volt capacitor) and the high surface area porous graphite electrodes of approximately equal effective surface area removed and used in combination with five different electrolyte solutions. As in Example 1, the first electrolyte solution contained just AN and TEABF4 with no additive and the remaining electrolyte solutions contained AN, TEABF4 and differing amounts of the additive M4. In the present case, the four electrolyte solutions containing additive contained 3%, 4%, 7% and 10% M4 (relative to the amount of TEABF4).

The same tests as in Example 1 were carried out to determine the effect of the additive on energy storage capacity. The results of the tests for Example 2 are presented below in tables 6 to 11.

TABLE 6

| | POSITIVE | NEGATIVE |
|---|---|---|
| 0% M4 ADDITIVE | ELECTRODE/v | ELECTRODE/v |
| ELECTROLYTE | 2.10 | 2.00 |
| BREAKDOWN LIMIT | | |
| APPLIED VOLTAGE/v | | |
| 3.00 | 1.58 | 1.42 |
| 3.50 | 1.84 | 1.66 |
| 3.55 | 1.87 | 1.68 |
| 3.60 | 1.90 | 1.70 |
| 3.65 | 1.92 | 1.73 |
| 3.70 | 1.95 | 1.75 |
| 3.75 | 1.98 | 1.78 |
| 3.80 | 2.00 | 1.80 |
| 3.85 | 2.03 | 1.82 |
| 3.90 | 2.05 | 1.85 |
| 3.95 | 2.08 | 1.87 |
| 4.00 | 2.11 | 1.89 |
| 4.05 | 2.13 | 1.92 |
| 4.10 | 2.16 | 1.94 |
| 4.15 | 2.19 | 1.96 |
| 4.20 | 2.21 | 1.99 |
| 4.25 | 2.24 | 2.01 |
| 4.30 | 2.26 | 2.04 |
| 4.35 | 2.29 | 2.06 |
| 4.40 | 2.32 | 2.08 |
| 4.45 | 2.34 | 2.11 |

TABLE 7

| | POSITIVE | NEGATIVE |
|---|---|---|
| 3% M4 ADDITIVE | ELECTRODE/v | ELECTRODE/v |
| ELECTROLYTE | 2.10 | 2.05 |
| BREAKDOWN LIMIT | | |
| APPLIED VOLTAGE/v | | |
| 3.00 | 1.73 | 1.27 |
| 3.50 | 2.02 | 1.48 |
| 3.55 | 2.05 | 1.50 |
| 3.60 | 2.08 | 1.52 |
| 3.65 | 2.10 | 1.55 |
| 3.70 | 2.13 | 1.57 |
| 3.75 | 2.16 | 1.59 |
| 3.80 | 2.19 | 1.61 |
| 3.85 | 2.22 | 1.63 |
| 3.90 | 2.25 | 1.65 |
| 3.95 | 2.28 | 1.67 |
| 4.00 | 2.31 | 1.69 |
| 4.05 | 2.34 | 1.71 |
| 4.10 | 2.36 | 1.74 |
| 4.15 | 2.39 | 1.76 |
| 4.20 | 2.42 | 1.78 |
| 4.25 | 2.45 | 1.80 |
| 4.30 | 2.48 | 1.82 |
| 4.35 | 2.51 | 1.84 |
| 4.40 | 2.54 | 1.86 |
| 4.45 | 2.34 | 1.88 |

TABLE 8

| | POSITIVE | NEGATIVE |
|---|---|---|
| 4% M4 ADDITIVE | ELECTRODE/v | ELECTRODE/v |
| ELECTROLYTE | 2.10 | 2.25 |
| BREAKDOWN LIMIT | | |
| APPLIED VOLTAGE/v | | |
| 3.00 | 1.51 | 1.49 |
| 3.50 | 1.76 | 1.74 |
| 3.55 | 1.79 | 1.76 |
| 3.60 | 1.81 | 1.79 |
| 3.65 | 1.84 | 1.81 |
| 3.70 | 1.86 | 1.84 |
| 3.75 | 1.89 | 1.86 |
| 3.80 | 1.91 | 1.89 |
| 3.85 | 1.94 | 1.91 |
| 3.90 | 1.96 | 1.94 |
| 3.95 | 1.99 | 1.96 |
| 4.00 | 2.01 | 1.99 |
| 4.05 | 2.04 | 2.01 |
| 4.10 | 2.06 | 2.04 |
| 4.15 | 2.09 | 2.06 |
| 4.20 | 2.11 | 2.09 |
| 4.25 | 2.14 | 2.11 |
| 4.30 | 2.16 | 2.14 |
| 4.35 | 2.19 | 2.16 |
| 4.40 | 2.21 | 2.19 |
| 4.45 | 2.24 | 2.21 |

TABLE 9

| | POSITIVE | NEGATIVE |
|---|---|---|
| 7% M4 ADDITIVE | ELECTRODE/v | ELECTRODE/v |
| ELECTROLYTE | 2.10 | 2.05 |
| BREAKDOWN LIMIT | | |
| APPLIED VOLTAGE/v | | |
| 3.00 | 1.56 | 1.44 |
| 3.50 | 1.82 | 1.68 |
| 3.55 | 1.85 | 1.70 |
| 3.60 | 1.87 | 1.73 |
| 3.65 | 1.90 | 1.75 |
| 3.70 | 1.92 | 1.78 |
| 3.75 | 1.95 | 1.80 |
| 3.80 | 1.98 | 1.82 |
| 3.85 | 2.00 | 1.85 |
| 3.90 | 2.03 | 1.87 |
| 3.95 | 2.05 | 1.90 |
| 4.00 | 2.08 | 1.92 |
| 4.05 | 2.11 | 1.94 |
| 4.10 | 2.13 | 1.97 |
| 4.15 | 2.16 | 1.99 |
| 4.20 | 2.18 | 2.02 |
| 4.25 | 2.21 | 2.04 |
| 4.30 | 2.24 | 2.06 |
| 4.35 | 2.26 | 2.09 |
| 4.40 | 2.29 | 2.11 |
| 4.45 | 2.31 | 2.14 |

TABLE 10

| | POSITIVE | NEGATIVE |
|---|---|---|
| 10% M4 ADDITIVE | ELECTRODE/v | ELECTRODE/v |
| ELECTROLYTE | 2.35 | 2.15 |
| BREAKDOWN LIMIT | | |
| APPLIED VOLTAGE/v | | |
| 3.00 | 1.57 | 1.43 |
| 3.50 | 1.83 | 1.67 |
| 3.55 | 1.86 | 1.69 |
| 3.60 | 1.88 | 1.72 |
| 3.65 | 1.91 | 1.74 |
| 3.70 | 1.94 | 1.76 |
| 3.75 | 1.96 | 1.79 |
| 3.80 | 1.99 | 1.81 |
| 3.85 | 2.01 | 1.84 |
| 3.90 | 2.04 | 1.86 |
| 3.95 | 2.07 | 1.88 |
| 4.00 | 2.09 | 1.91 |
| 4.05 | 2.12 | 1.93 |
| 4.10 | 2.15 | 1.95 |
| 4.15 | 2.17 | 1.98 |
| 4.20 | 2.20 | 2.00 |
| 4.25 | 2.22 | 2.03 |
| 4.30 | 2.25 | 2.05 |
| 4.35 | 2.28 | 2.07 |
| 4.40 | 2.30 | 2.10 |
| 4.45 | 2.33 | 2.12 |

TABLE 11

| | MAXIMUM VOLTAGE | |
|---|---|---|
| | WINDOW/ | ENERGY STORAGE |
| AMOUNT M4/% | volts | INCREASE/% |
| 0 | 3.95 | 0 |
| 3 | 3.65 | −15 |
| 4 | 4.15 | 10 |
| 7 | 4.00 | 2.5 |
| 10 | 4.45 | 27 |

The addition to the electrolyte of a small amount of M4 had a significant effect on the capacity of the positive and negative electrodes, and increased the energy storage capacity of the capacitor system by as much as 27%.

### Example 3

Six capacitor systems were constructed which consisted of glassy carbon electrodes and an electrolyte solution containing PC and M4 (1.0 M). The first capacitor system employed an electrolyte containing just PC and M4 with no additive. The other five capacitor systems employed electrolyte solution containing PC, M4 (1.0 M) and 2%, 4%, 6%, 8% and 10% EPFPC (relative to the amount of M4).

The electrolyte breakdown limit was determined using the above described CV method for each capacitor system. A series of voltages was then applied across each capacitor system and the individual positive and negative electrode voltage differentials relative to the electrolyte determined as described above. The results obtained are set out below in tables 12 to 17.

The maximum voltage window for each capacitor system (shown in table 18) was determined by comparing the measured individual positive and negative electrode voltage differentials to the respective positive and negative electrode electrolyte breakdown limits.

TABLE 12

| | POSITIVE | NEGATIVE |
|---|---|---|
| 0% EPFPC ADDITIVE | ELECTRODE/v | ELECTRODE/v |
| ELECTROLYTE | 2.80 | 1.95 |
| BREAKDOWN LIMIT | | |
| APPLIED VOLTAGE/v | | |
| 3.00 | 1.65 | 1.35 |
| 3.50 | 1.93 | 1.58 |
| 3.55 | 1.95 | 1.60 |
| 3.60 | 1.98 | 1.62 |
| 3.65 | 2.01 | 1.64 |
| 3.70 | 2.04 | 1.67 |
| 3.75 | 2.06 | 1.69 |
| 3.80 | 2.09 | 1.71 |
| 3.85 | 2.12 | 1.73 |
| 3.90 | 2.15 | 1.76 |
| 3.95 | 2.17 | 1.78 |
| 4.00 | 2.20 | 1.80 |
| 4.05 | 2.23 | 1.82 |
| 4.10 | 2.26 | 1.85 |
| 4.15 | 2.28 | 1.87 |
| 4.20 | 2.31 | 1.89 |
| 4.25 | 2.34 | 1.91 |
| 4.30 | 2.37 | 1.94 |
| 4.35 | 2.39 | 1.96 |
| 4.40 | 2.42 | 1.98 |
| 4.45 | 2.45 | 2.00 |

TABLE 13

| | POSITIVE | NEGATIVE |
|---|---|---|
| 2% EPFPC ADDITIVE | ELECTRODE/v | ELECTRODE/v |
| ELECTROLYTE | 2.80 | 1.95 |
| BREAKDOWN LIMIT | | |
| APPLIED VOLTAGE/v | | |
| 3.00 | 1.75 | 1.25 |
| 3.50 | 2.04 | 1.46 |
| 3.55 | 2.07 | 1.48 |
| 3.60 | 2.10 | 1.50 |
| 3.65 | 2.13 | 1.52 |
| 3.70 | 2.16 | 1.54 |
| 3.75 | 2.19 | 1.56 |
| 3.80 | 2.22 | 1.58 |
| 3.85 | 2.25 | 1.60 |
| 3.90 | 2.28 | 1.63 |
| 3.95 | 2.30 | 1.65 |
| 4.00 | 2.33 | 1.67 |
| 4.05 | 2.36 | 1.69 |
| 4.10 | 2.39 | 1.71 |
| 4.15 | 2.42 | 1.73 |
| 4.20 | 2.45 | 1.75 |
| 4.25 | 2.48 | 1.77 |
| 4.30 | 2.51 | 1.79 |
| 4.35 | 2.54 | 1.81 |
| 4.40 | 2.57 | 1.83 |
| 4.45 | 2.45 | 1.85 |
| 4.50 | 2.63 | 1.88 |
| 4.55 | 2.65 | 1.90 |
| 4.60 | 2.68 | 1.92 |
| 4.65 | 2.56 | 1.94 |

TABLE 14

| | POSITIVE | NEGATIVE |
|---|---|---|
| 4% EPFPC ADDITIVE | ELECTRODE/v | ELECTRODE/v |
| ELECTROLYTE | 2.80 | 1.95 |
| BREAKDOWN LIMIT | | |
| APPLIED VOLTAGE/v | | |
| 3.00 | 1.75 | 1.25 |
| 3.50 | 2.04 | 1.46 |
| 3.55 | 2.07 | 1.48 |
| 3.60 | 2.10 | 1.50 |
| 3.65 | 2.13 | 1.52 |
| 3.70 | 2.16 | 1.54 |
| 3.75 | 2.19 | 1.56 |
| 3.80 | 2.22 | 1.58 |
| 3.85 | 2.25 | 1.60 |
| 3.90 | 2.28 | 1.63 |
| 3.95 | 2.30 | 1.65 |
| 4.00 | 2.33 | 1.67 |
| 4.05 | 2.36 | 1.69 |
| 4.10 | 2.39 | 1.71 |
| 4.15 | 2.42 | 1.73 |
| 4.20 | 2.45 | 1.75 |
| 4.25 | 2.48 | 1.77 |
| 4.30 | 2.51 | 1.79 |
| 4.35 | 2.54 | 1.81 |
| 4.40 | 2.57 | 1.83 |
| 4.45 | 2.60 | 1.85 |
| 4.50 | 2.63 | 1.88 |
| 4.55 | 2.65 | 1.90 |
| 4.60 | 2.68 | 1.92 |
| 4.65 | 2.71 | 1.94 |
| 4.70 | 2.74 | 1.96 |

TABLE 15

| | POSITIVE | NEGATIVE |
|---|---|---|
| 6% EPFPC ADDITIVE | ELECTRODE/v | ELECTRODE/v |
| ELECTROLYTE | 2.80 | 1.95 |
| BREAKDOWN LIMIT | | |
| APPLIED VOLTAGE/v | | |
| 3.00 | 1.80 | 1.20 |
| 3.50 | 2.10 | 1.40 |
| 3.55 | 2.13 | 1.42 |
| 3.60 | 2.16 | 1.44 |
| 3.65 | 2.19 | 1.46 |
| 3.70 | 2.22 | 1.48 |
| 3.75 | 2.25 | 1.50 |
| 3.80 | 2.28 | 1.52 |
| 3.85 | 2.31 | 1.54 |
| 3.90 | 2.34 | 1.56 |
| 3.95 | 2.37 | 1.58 |
| 4.00 | 2.40 | 1.60 |
| 4.05 | 2.43 | 1.62 |
| 4.10 | 2.46 | 1.64 |
| 4.15 | 2.49 | 1.66 |
| 4.20 | 2.52 | 1.68 |
| 4.25 | 2.55 | 1.70 |
| 4.30 | 2.58 | 1.72 |
| 4.35 | 2.61 | 1.74 |
| 4.40 | 2.64 | 1.76 |
| 4.45 | 2.67 | 1.78 |
| 4.50 | 2.70 | 1.80 |
| 4.55 | 2.73 | 1.82 |
| 4.60 | 2.76 | 1.84 |
| 4.65 | 2.79 | 1.86 |
| 4.70 | 2.82 | 1.88 |
| 4.75 | 2.85 | 1.90 |

TABLE 16

| | POSITIVE | NEGATIVE |
|---|---|---|
| 8% EPFPC ADDITIVE | ELECTRODE/v | ELECTRODE/v |
| ELECTROLYTE | 2.80 | 1.95 |
| BREAKDOWN LIMIT | | |
| APPLIED VOLTAGE/v | | |
| 3.00 | 1.81 | 1.19 |
| 3.50 | 2.10 | 1.40 |
| 3.55 | 2.13 | 1.42 |
| 3.60 | 2.16 | 1.44 |
| 3.65 | 2.19 | 1.46 |
| 3.70 | 2.22 | 1.48 |
| 3.75 | 2.25 | 1.50 |
| 3.80 | 2.28 | 1.52 |
| 3.85 | 2.31 | 1.54 |
| 3.90 | 2.34 | 1.56 |
| 3.95 | 2.37 | 1.58 |
| 4.00 | 2.40 | 1.60 |
| 4.05 | 2.43 | 1.62 |
| 4.10 | 2.46 | 1.64 |
| 4.15 | 2.49 | 1.66 |
| 4.20 | 2.52 | 1.68 |
| 4.25 | 2.55 | 1.70 |
| 4.30 | 2.58 | 1.72 |
| 4.35 | 2.61 | 1.74 |
| 4.40 | 2.64 | 1.76 |
| 4.45 | 2.67 | 1.78 |
| 4.50 | 2.70 | 1.80 |
| 4.55 | 2.73 | 1.82 |
| 4.60 | 2.76 | 1.84 |
| 4.65 | 2.79 | 1.86 |
| 4.70 | 2.82 | 1.88 |
| 4.75 | 2.85 | 1.90 |
| 4.80 | 2.88 | 1.92 |

TABLE 17

| | POSITIVE | NEGATIVE |
|---|---|---|
| 10% EPFPC ADDITIVE | ELECTRODE/v | ELECTRODE/v |
| ELECTROLYTE | 2.80 | 1.95 |
| BREAKDOWN LIMIT | | |
| APPLIED VOLTAGE/v | | |
| 3.00 | 1.81 | 1.19 |
| 3.50 | 2.11 | 1.39 |
| 3.55 | 2.14 | 1.41 |
| 3.60 | 2.17 | 1.43 |
| 3.65 | 2.20 | 1.45 |
| 3.70 | 2.23 | 1.47 |
| 3.75 | 2.26 | 1.49 |
| 3.80 | 2.29 | 1.51 |
| 3.85 | 2.32 | 1.53 |
| 3.90 | 2.35 | 1.55 |
| 3.95 | 2.38 | 1.57 |
| 4.00 | 2.41 | 1.59 |
| 4.05 | 2.44 | 1.61 |
| 4.10 | 2.47 | 1.63 |
| 4.15 | 2.50 | 1.65 |
| 4.20 | 2.53 | 1.67 |
| 4.25 | 2.56 | 1.69 |
| 4.30 | 2.59 | 1.71 |
| 4.35 | 2.62 | 1.73 |
| 4.40 | 2.65 | 1.75 |
| 4.45 | 2.68 | 1.77 |
| 4.50 | 2.72 | 1.79 |
| 4.55 | 2.75 | 1.80 |
| 4.60 | 2.78 | 1.82 |
| 4.65 | 2.81 | 1.84 |
| 4.70 | 2.84 | 1.86 |
| 4.75 | 2.87 | 1.88 |
| 4.80 | 2.90 | 1.90 |
| 4.85 | 2.93 | 1.92 |

TABLE 18

| | MAXIMUM VOLTAGE | ENERGY STORAGE |
|---|---|---|
| AMOUNT EPFPC/% | WINDOW/volts | INCREASE/% |
| 0 | 4.30 | 0 |
| 2 | 4.65 | 17 |
| 4 | 4.65 | 17 |
| 6 | 4.65 | 17 |
| 8 | 4.65 | 17 |
| 10 | 4.60 | 14 |

As can be seen from table 18, the addition to the electrolyte of a small amount of EPFPC had a significant effect on the capacity of the positive and negative electrodes, and increased the energy storage capacity of the capacitor system by up to 17%.

### Example 4

Six capacitor systems were constructed which consisted of glassy carbon electrodes and an electrolyte solution containing EPFPC and M4 (1.0 M). The first capacitor system employed an electrolyte containing just EPFPC and M4 with no additive. The other five capacitor systems employed electrolyte solutions containing EPFPC, M4 (1.0 M) and 2%, 4%, 6%, 8% and 10% PC (relative to the amount of M4).

The electrolyte breakdown limit was determined using the above described CV method for each capacitor system. A series of voltages was then applied across each capacitor system and the individual positive and negative electrode voltage differentials relative to the electrolyte determined as described above. The results obtained are set out below in tables 19 to 24.

The maximum voltage window for each capacitor system (shown in table 25) was determined by comparing the measured individual positive and negative electrode voltage differentials to the respective positive and negative electrode electrolyte breakdown limits.

TABLE 19

| | POSITIVE | NEGATIVE |
|---|---|---|
| 0% PC ADDITIVE | ELECTRODE/v | ELECTRODE/v |
| ELECTROLYTE | 2.40 | 1.85 |
| BREAKDOWN LIMIT | | |
| APPLIED VOLTAGE/v | | |
| 3.00 | 1.43 | 1.57 |
| 3.50 | 1.67 | 1.83 |
| 3.55 | 1.69 | 1.86 |
| 3.60 | 1.72 | 1.88 |
| 3.65 | 1.74 | 1.91 |

TABLE 20

| | POSITIVE | NEGATIVE |
|---|---|---|
| 2% PC ADDITIVE | ELECTRODE/v | ELECTRODE/v |
| ELECTROLYTE | 2.40 | 1.85 |
| BREAKDOWN LIMIT | | |
| APPLIED VOLTAGE/v | | |
| 3.00 | 1.50 | 1.50 |
| 3.50 | 1.75 | 1.75 |
| 3.55 | 1.78 | 1.78 |
| 3.60 | 1.80 | 1.80 |
| 3.65 | 1.83 | 1.83 |
| 3.70 | 1.85 | 1.85 |
| 3.75 | 1.88 | 1.88 |
| 3.80 | 1.90 | 1.90 |

TABLE 21

| | POSITIVE | NEGATIVE |
|---|---|---|
| 4% PC ADDITIVE | ELECTRODE/v | ELECTRODE/v |
| ELECTROLYTE | 2.40 | 1.85 |
| BREAKDOWN LIMIT | | |
| APPLIED VOLTAGE/v | | |
| 3.00 | 1.49 | 1.51 |
| 3.50 | 1.74 | 1.76 |
| 3.55 | 1.76 | 1.79 |
| 3.60 | 1.79 | 1.81 |
| 3.65 | 1.81 | 1.84 |
| 3.70 | 1.84 | 1.86 |
| 3.75 | 1.86 | 1.89 |
| 3.80 | 1.89 | 1.91 |

TABLE 22

| | POSITIVE | NEGATIVE |
|---|---|---|
| 6% PC ADDITIVE | ELECTRODE/v | ELECTRODE/v |
| ELECTROLYTE | 2.40 | 1.85 |
| BREAKDOWN LIMIT | | |
| APPLIED VOLTAGE/v | | |
| 3.00 | 1.56 | 1.44 |
| 3.50 | 1.82 | 1.68 |
| 3.55 | 1.85 | 1.70 |
| 3.60 | 1.87 | 1.73 |
| 3.65 | 1.90 | 1.75 |
| 3.70 | 1.92 | 1.78 |
| 3.75 | 1.95 | 1.80 |
| 3.80 | 1.98 | 1.82 |
| 3.85 | 2.00 | 1.85 |
| 3.90 | 2.03 | 1.87 |
| 3.95 | 2.05 | 1.90 |

TABLE 23

| | POSITIVE | NEGATIVE |
|---|---|---|
| 8% PC ADDITIVE | ELECTRODE/v | ELECTRODE/v |
| ELECTROLYTE | 2.40 | 1.85 |
| BREAKDOWN LIMIT | | |
| APPLIED VOLTAGE/v | | |
| 3.00 | 1.59 | 1.41 |
| 3.50 | 1.82 | 1.68 |
| 3.55 | 1.85 | 1.70 |
| 3.60 | 1.87 | 1.73 |
| 3.65 | 1.90 | 1.75 |
| 3.70 | 1.92 | 1.78 |
| 3.75 | 1.95 | 1.80 |
| 3.80 | 1.98 | 1.82 |
| 3.85 | 2.00 | 1.85 |
| 3.90 | 2.03 | 1.87 |
| 3.95 | 2.05 | 1.90 |

TABLE 24

| | POSITIVE | NEGATIVE |
|---|---|---|
| 10% PC ADDITIVE | ELECTRODE/v | ELECTRODE/v |
| ELECTROLYTE | 2.40 | 1.85 |
| BREAKDOWN LIMIT | | |
| APPLIED VOLTAGE/v | | |
| 3.00 | 1.60 | 1.40 |
| 3.50 | 1.87 | 1.63 |
| 3.55 | 1.89 | 1.66 |
| 3.60 | 1.92 | 1.68 |
| 3.65 | 1.95 | 1.70 |
| 3.70 | 1.97 | 1.73 |
| 3.75 | 2.00 | 1.75 |
| 3.80 | 2.03 | 1.77 |
| 3.85 | 2.05 | 1.80 |
| 3.90 | 2.08 | 1.82 |
| 3.95 | 2.11 | 1.84 |
| 4.00 | 2.13 | 1.87 |

TABLE 25

| | MAXIMUM | ENERGY |
|---|---|---|
| | VOLTAGE | STORAGE |
| AMOUNT PC/% | WINDOW/volts | INCREASE/% |
| 0 | 3.50 | 0 |
| 2 | 3.70 | 12 |
| 4 | 3.65 | 9 |
| 6 | 3.85 | 21 |
| 8 | 3.85 | 21 |
| 10 | 3.95 | 27 |

As can be seen from table 25, the addition to the electrolyte of a small amount of PC had a significant effect on the capacity of the positive and negative electrodes, and increased the energy storage capacity of the capacitor system by up to 27%.

### Example 5

Four capacitor systems were constructed which consisted of glassy carbon electrodes and an electrolyte solution containing PC and M4 (1.0 M). The first capacitor system employed an electrolyte containing just PC and M4 with no additive. The other three capacitor systems employed electrolyte solution containing PC, M4 (1.0 M) and 3%, 6%, and 10% SI1 (relative to the amount of M4).

The electrolyte breakdown limit was determined using the above described CV method for each capacitor system. A series of voltages was then applied across each capacitor system and the individual positive and negative electrode voltage differentials relative to the electrolyte determined as described above. The results obtained are set out below in tables 26 to 29.

The maximum voltage window for each capacitor system (shown in table 30) was determined by comparing the measured individual positive and negative electrode voltage differentials to the respective positive and negative electrode electrolyte breakdown limits.

TABLE 26

| | POSITIVE | POSITIVE |
|---|---|---|
| 0% SI 1 ADDITIVE | ELECTRODE/v | ELECTRODE/v |
| ELECTROLYTE | 1.95 | 2.05 |
| BREAKDOWN LIMIT | | |
| APPLIED VOLTAGE/v | | |
| 3.45 | 1.54 | 1.91 |
| 3.50 | 1.56 | 1.94 |
| 3.55 | 1.59 | 1.96 |
| 3.60 | 1.61 | 1.99 |
| 3.65 | 1.63 | 2.02 |
| 3.70 | 1.65 | 2.05 |
| 3.75 | 1.68 | 2.08 |
| 3.80 | 1.70 | 2.10 |
| 3.85 | 1.72 | 2.13 |

TABLE 27

| | POSITIVE | POSITIVE |
|---|---|---|
| 3% SI 1 ADDITIVE | ELECTRODE/v | ELECTRODE/v |
| ELECTROLYTE | 1.95 | 2.05 |
| BREAKDOWN LIMIT | | |
| APPLIED VOLTAGE/v | | |
| 3.45 | 1.56 | 1.89 |
| 3.50 | 1.59 | 1.91 |
| 3.55 | 1.61 | 1.94 |
| 3.60 | 1.63 | 1.97 |
| 3.65 | 1.65 | 2.00 |
| 3.70 | 1.68 | 2.02 |
| 3.75 | 1.70 | 2.05 |
| 3.80 | 1.72 | 2.08 |
| 3.85 | 1.75 | 2.10 |

TABLE 28

| | POSITIVE | POSITIVE |
|---|---|---|
| 6% SI 1 ADDITIVE | ELECTRODE/v | ELECTRODE/v |
| ELECTROLYTE | 1.95 | 2.05 |
| BREAKDOWN LIMIT | | |
| APPLIED VOLTAGE/v | | |
| 3.70 | 1.80 | 1.90 |
| 3.75 | 1.83 | 1.93 |
| 3.80 | 1.85 | 1.95 |
| 3.85 | 1.87 | 1.98 |
| 3.90 | 1.90 | 2.00 |
| 3.95 | 1.92 | 2.03 |
| 4.00 | 1.95 | 2.05 |
| 4.05 | 1.97 | 2.08 |
| 4.10 | 2.00 | 2.10 |

TABLE 29

| | POSITIVE | POSITIVE |
|---|---|---|
| 10% SI 1 ADDITIVE | ELECTRODE/v | ELECTRODE/v |
| ELECTROLYTE | 1.95 | 2.05 |
| BREAKDOWN LIMIT | | |
| APPLIED VOLTAGE/v | | |
| 3.45 | 1.79 | 1.66 |
| 3.50 | 1.82 | 1.68 |
| 3.55 | 1.85 | 1.70 |
| 3.60 | 1.87 | 1.73 |
| 3.65 | 1.90 | 1.75 |
| 3.70 | 1.92 | 1.78 |
| 3.75 | 1.95 | 1.80 |
| 3.80 | 1.98 | 1.82 |
| 3.85 | 2.00 | 1.85 |

TABLE 30

| | MAXIMUM | ENERGY |
|---|---|---|
| | VOLTAGE | STORAGE |
| AMOUNT SI1/% | WINDOW/volts | INCREASE/% |
| 0 | 3.70 | 0 |
| 3 | 3.75 | 3 |
| 6 | 4.00 | 17 |
| 10 | 3.75 | 3 |

As can be seen from table 30, the addition to the electrolyte of a small amount of SI1 had a significant effect on the capacity of the positive and negative electrodes, and increased the energy storage capacity of the capacitor system by up to 17%.

### Example 6

A commercially available capacitor was dried and filled with an electrolyte according to a preferred embodiment of the present invention. The capacitor possessed the following properties: weight 54 g; diameter 32 mm; length 60 mm; top contact positive; case negative; nominal voltage standard format 2.5 volts; cylindrical wound electrodes of aluminium coated with high surface area carbon The electrolyte comprised AN solvent, TEABF4 salt (1 M), and M1 additive. Five capacitor systems were investigated varying only in the amount of M1 additive present in the electrolyte. The amounts of M1 additive used were 0%, 7%, 8%, 10% and 14%. The capacitor was then tested using the apparatus described above with reference to FIG. 3.

FIG. 4a shows a graph of the results obtained for the capacitor with an applied voltage of 2.5 v. It can be seen that an increase in the concentration of M1 in the electrolyte had the effect of reducing the positive voltage differential which may be desirable where a reduction in the positive voltage differential is required in order to access wider operational voltage windows for the electrolyte in a particular capacitor system.

FIG. 4b illustrates the results obtained from the capacitor when the voltage applied was 2.8 v. Again, it can be seen that the positive voltage differential decreases as the concentration of M1 in the electrolyte increases, which for the same reasons as above, may be desirable in certain capacitors systems.

### Example 7

A commercially available capacitor was dried and filled with an electrolyte according to a preferred embodiment of the present invention. The capacitor possessed the following properties: weight 54 g; diameter 32 mm; length 60 mm; top contact positive; case negative; nominal voltage standard format 2.5 volts; cylindrical wound electrodes of aluminium coated with high surface area carbon The electrolyte comprised AN solvent, TEABF4 salt (1 M), and M4 additive. Five capacitor systems were investigated varying only in the amount of M4 additive present in the electrolyte. The amounts of M4 additive used were 0%, 2%, 6% and 10%. The capacitor was then tested using the apparatus described above with reference to FIG. 3.

FIG. 5a depicts the results obtained for varying concentrations of M4 when the voltage applied between the plates of the capacitor was 2.5 v. FIG. 5b depicts the results obtained for varying concentrations of M4 when the voltage applied between the plates of the capacitor 9 was 2.8 v.

It can be seen from FIGS. 5a and 5b that, initially, addition of the additive M4 increased the positive voltage differential, but that the positive voltage differential decreased when the concentration of M4 exceeded about 6%. Different percentages of the additive M4 may therefore be desirable where an increase or decrease of the positive voltage differential is required in order to access wider operational voltage windows for an electrolyte.

### Example 8

The discharge of commercially available capacitors containing a standard electrolyte comprising AN solvent and TEABF4 salt (1 M), and two different electrolytes according to the present invention was investigated according to European Standard IEC 62391-1, specifically, using the method outlined in paragraph 4.5.1 of the Standard.

The capacitors used possessed the following properties: weight 54 g; diameter 32 mm; length 60 mm; top contact positive; case negative; nominal voltage standard format 2.5 volts; cylindrical wound electrodes of aluminium coated with high surface area carbon. The capacitors were dried and filled in the same manner as described above in relation to the capacitors tested using the apparatus of FIG. 3. Three identical capacitors were used to obtain each data point and all results were obtained at 65° C. using an operating voltage of 2.8 v. The temperature at which the testing was undertaken was elevated to provide an indication of the long-term performance of the capacitors.

For instance, it is known that the testing of the capacitors at 65° C. over ninety days is equivalent to testing the capacitors at around room temperature over a period of around ten years. Over the testing period of ninety days, manufacturers of capacitors would like the storage capacity of the capacitor to drop by no more than 25%. In other words, if the storage capacity decreases by 25% or less over the testing period of ninety days, the capacitor is taken to be durable enough for use, and is therefore taken to be satisfactory.

The results shown in FIGS. 6a and 6b include three data sets.

A first data set includes the results obtained for the capacitor incorporating an electrolyte comprising an AN solvent, TEABF4 salt (1 M) with 14% M1 additive. The capacitor exhibited a positive voltage differential of 1.55 v and a negative voltage differential of −1.25 v.

A second data set shows the results obtained for the capacitor incorporating an electrolyte comprising an AN solvent, TEABF4 salt (1 M) with 2% M4 additive. The capacitor exhibited a positive voltage differential of 1.8 v and a negative voltage differential of −1.0 v.

A third data set shows the results obtained for the capacitor incorporating the standard commercial electrolyte comprising an AN solvent and TEABF4 salt (1 M), but no additive. This capacitor exhibited a positive voltage differential of 1.71 v and a negative voltage differential of −1.09 v.

FIG. 6a shows the results for the capacitors over a period of fifteen days. It can be seen that even over fifteen days, the capacitors having electrolytes with the M1 and M4 additive are already outperforming the standard capacitors. That is, the storage capacity of the capacitors having electrolytes with the M1 and M4 additive decreases more slowly over time than the storage capacity of the standard capacitors. It can be seen that this benefit is enjoyed from the very first day of the test onward. It can also be seen that the capacitor employing an electrolyte with 14% M1 additive outperforms the capacitor employing an electrolyte with 2% M4 additive.

FIG. 6b shows a ninety day extrapolation of the results obtained over fifteen days. It can readily be seen that the standard capacitor is not satisfactory, in that its storage capacity decreases by more than 25% in ninety days. Indeed, it can be seen that the standard capacitor loses 25% of its storage capacity in just over fifty days. In contrast, it can be seen that the capacitor employing an electrolyte comprising with 14% M1 additive retains 75% of its capacitance after 90 days and is therefore satisfactory.

After the capacitors had been tested, it was found that the capacitors containing an electrolyte having either an M1 or M4 additive contained 70 ppm (parts per million) water. In comparison, the electrolytes of the standard capacitors were found to contain only 25 ppm (parts per million) water. It is commonly believed that the more water an electrolyte of a capacitor contains, the quicker the storage capacity of the capacitor will degrade. However, it can be seen from FIGS. 6a and 6b that this is surprisingly not the case for the capacitors containing electrolytes in accordance with preferred embodiments of the present invention incorporating the M1 or M4 additive. This result can be interpreted as meaning that the use of the additive reduces the sensitivity to excessive water and/or that the effect of the additive on the long term storage capacity of the capacitor reduces the degradation in performance caused by excessive of water.

### Example 9

The capacitance of five electrode/electrolyte systems was determined using standard AC impedance techniques. A glassy carbon electrode of known area (7.0685775 mm²) was used. The standard electrolyte comprised AN solvent and TEABF4 (1 M). The four remaining electrolytes comprised the same solvent and salt as the standard solution but further included the following additives: 2% M1; 14% M1; 2% M4; and 5% M4. The percentage amount of each additive is relative to the amount of the electrolyte salt.

The results presented below in FIG. 7 show the effect of the additives on the capacitance of the electrode at varying voltages.

The results presented clearly show that both the additives M1 and M4 had a significant effect on the capacitance when compared with the standard solution. The M1 additions resulted in a peak in capacitance at 0.9 v and 1.1 v for 2% and 14% M1 respectively. The M4 addition at levels of 2% and 5% resulted in an increase in capacitance at higher voltages when compared with the standard electrolyte solution.

The results shown in FIG. 7 clearly indicate that the additives are altering the structure of the double layer and hence causing the observed changes in the measured capacitance.

### Example 10

The Jow et al. method (Xu, Ding & Jow; Electrochimica Acta, 46, 2001, 1823-1827) was applied to a commercially available capacitor employing a standard commercial electrolyte. The method was then repeating twice using a capacitor of the same specification but employing two different electrolytes according to preferred embodiments of the present invention. The standard electrolyte comprised AN solvent and TEABF4 salt (1 M). The first inventive electrolyte comprised the same solvent and salt but further included 5% M4 additive (relative to the amount of the salt) and the second inventive electrolyte comprised the same solvent and salt but further included 14% M1 additive. The capacitor possessed the following properties: weight 54 g; diameter 32 mm; length 60 mm; top contact positive; case negative; nominal voltage standard format 2.5 volts; cylindrical wound electrodes of aluminium coated with high surface area carbon.

The results of the application of the Jow et al. analysis (Xu, Ding & Jow; Electrochimica Acta, 46, 2001, 1823-1827) to the three capacitor systems are depicted below in FIG. 8. The dashed curve with data points shown as diamonds is an electrochemistry stability curve for the standard electrolyte. The solid curve with data points shown as squares is an electrochemistry stability curve for the standard electrolyte incorporating 5% M4 additive in accordance with a preferred embodiment of the present invention. The solid curve with data points shown as squares is an electrochemistry stability curve for the standard electrolyte incorporating 14% M1 additive in accordance with a preferred embodiment of the present invention. The four sets of straight lines (each set consisting of two vertical lines linked by a horizontal line) indicate the positive and negative voltage differentials for the capacitor using the standard electrolyte solution at 2.5 v operating voltage (dotted line), the standard electrolyte solution at 2.8 v operating voltage (dot/dash line), the electrolyte incorporating 5% M4 additive at 2.5 v operating voltage (thin solid line), and the electrolyte incorporating 5% M4 additive at 2.8 v operating voltage (thick solid line).

It can be observed from FIG. 8 that the curve for the standard electrolyte solution at positive voltages shows higher electrochemical activity than the corresponding curve for the inventive electrolyte incorporating the M4 additive. The curve for the standard electrolyte solution at negative voltages shows lower electrochemical activity than the inventive electrolyte. While the inventor does not wish to be bound by any particular theory it is believed that the increased amount of electrochemistry taking place in the M4 containing electrolyte than the standard electrolyte at negative voltages may be at least partially attributable to increased levels of moisture present in the capacitor tested using the electrolyte with the M4 containing additive than the standard capacitor/electrolyte system.

At positive voltages, it can be concluded that the additive M4 ensures that less electrochemistry is taking place, even at 2.8 volts (which is higher than the standard operating voltage of 2.5 volts), than when the standard electrolyte is used with an applied voltage of 2.5 volts. At negative voltages, even though more electrochemistry is occurring when the M4 additive is used than when no additive is added, the Jow ratio for the M4 additive at 2.8 volts is still lower than 0.04 and clear of the point of electrochemical breakdown at about −1.5 volts. On this basis the operating voltage of the system with the production electrodes is judged to be 2.8 volts, which includes the effects of the internal geometry of the capacitors since the differential voltages are measured in real commercially available capacitors. Up to a positive applied voltage of around 1.8 volts the curves for the standard electrolyte and the electrolyte incorporating the M1 additive are broadly similar, with the curve for the inventive electrolyte showing less electrochemistry in the 1.5 to 1.8 volt range. At negative applied voltages up to around −1.4 volts the curves for the standard electrolyte and the inventive electrolyte are again generally similar, with the curves indicating that that less electrochemistry is taking place in the −0.8 to −1.4 volt range for the inventive electrolyte incorporating M1 than the standard electrolyte.

1. An electrolyte for use in a capacitor, the electrolyte comprising a solvent; a salt comprising a first anion and a first cation; and an additive, wherein the additive is provided in a sufficient quantity to modify a voltage differential across an electric double layer associated with at least one electrode of said capacitor such that said voltage differential is closer to a predetermined voltage breakdown limit for the electrolyte and said at least one electrode than a voltage differential across an electric double layer associated with said at least one electrode and a further electrolyte comprising said solvent and said salt but no additive.

2. An electrolyte according to claim 1, wherein the additive is provided in a sufficient quantity such that said voltage differential substantially matches the predetermined voltage breakdown limit.

3. An electrolyte according to claim 1, wherein the additive is provided in a sufficient quantity to modify first and second voltage differentials across electric double layers associated with respective first and second electrodes of said capacitor such that said first voltage differential is closer to a first predetermined voltage breakdown limit for the electrolyte and said first electrode than a third voltage differential across an electric double layer associated with said first electrode and said further electrolyte and said second voltage differential is closer to a second predetermined voltage breakdown limit for the electrolyte and said second electrode than a fourth voltage differential across an electric double layer associated with said second electrode and said further electrolyte.

4. An electrolyte according to claim 3, wherein the additive is provided in a sufficient quantity such that said first and second voltage differentials substantially match said first and second predetermined voltage breakdown limits respectively.

5. An electrolyte according to claim 1, wherein the additive is provided in a sufficient quantity to at least partially offset a reduction in the voltage differential across said at least one electric double layer compared to the predetermined voltage breakdown limit for the electrolyte that is attributable to the nature of the electrolyte solvent and salt.

6. An electrolyte according to claim 1, wherein the additive is provided in a sufficient quantity to at least partially offset a reduction in the voltage differential across said at least one electric double layer compared to the predetermined voltage breakdown limit of the electrolyte that is attributable to said at least one electrode possessing a surface area that is less than a predetermined optimum surface area for said at least one electrode.

7. An electrolyte according to claim 3, wherein the additive is provided in a sufficient quantity to at least partially offset a reduction in at least one of the first and second voltage differentials compared to the respective first and second predetermined voltage breakdown limits that is attributable to said first and second electrodes possessing unequal surface areas.

8. An electrolyte according to claim 1, wherein the concentration of the additive in the electrolyte is less than the concentration of the salt in the electrolyte.

9. An electrolyte according to claim 8, wherein the concentration of the additive in the electrolyte is up to about 75% of the concentration of the salt in the electrolyte.

10. An electrolyte according to claim 1, wherein the radius of the additive species present in the electrolyte is different to at least one of the molecular radius of the solvent molecules and the ionic radius of at least one of the first anion and the first cation.

11. An electrolyte according to claim 1, wherein the additive comprises at least one of a second anion of larger ionic radius than the first anion, the concentration of the second anion being lower than the concentration of the first anion; and a second cation of larger ionic radius than the first cation, the concentration of the second cation being lower than the concentration of the first cation.

12. An electrolyte according to claim 11, wherein the additive comprises said second anions and the concentration of the second anions is less than about 75% of the concentration of the first anions.

13. An electrolyte according to claim 11, wherein the additive comprises said second cations and the concentration of the second cations is less than about 75% of the concentration of the first cations.

14. An electrolyte according to claim 11, wherein the additive comprises said second anions and the ionic radius of the second anion is at least about 10% larger than the ionic radius of the first anion.

15. An electrolyte according to claim 11, wherein the additive comprises said second cations and the ionic radius of the second cation is at least about 10% larger than the ionic radius of the first cations.

16. An electrolyte according to claim 11, wherein the additive comprises second cations selected from the group consisting of substituted or unsubstituted alkylpyrrolidinium ions, substituted or unsubstituted alkylammonium ions, substituted or unsubstituted alkylphosphonium ions, substituted or unsubstituted alkylimidazolium ions and substituted or unsubstituted alkylsulphonium ions.

17. An electrolyte according to claim 11, wherein the additive comprises second cations selected from the group consisting of 1-butyl-1-methylpyrrolidinium ions, ethyl-dimethyl-propylammonium ions, tetramethylammonium ions, tetraethylammonium ions, tetrabutylammonium ions, trihexyl(tetradecyl)phosphonium ions, 1-butyl-3-methylimidazolium ions, methyl-trioctylammonium ions, ethyl-methyl-imidazolium ions, 1-hexyl-3-methylimidazolium ions and triethylsulphonium ions.

18. An electrolyte according to claim 11, wherein the additive comprises second anions selected from the group consisting of substituted or unsubstituted phosphate ions, substituted or unsubstituted sulfonate ions, substituted or unsubstituted borate ions and substituted or unsubstituted imide ions.

19. An electrolyte according to claim 18, wherein said anions contain at least one alkyl group selected from the group consisting of methyl, ethyl, propyl and butyl.

20. An electrolyte according to claim 11, wherein the additive comprises second anions selected from the group consisting of hexafluorophosphate, tris(pentafluoroethyl)trifluorophosphate, trifluoromethylsulfonate, bis[oxalato(2)]borate, pentafluoroethyltrifluoroborate, bis(trifluoromethylsulfonyl)imide and tetrafluoroborate.

21. An electrolyte according to claim 11, wherein the additive is a salt selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate, tetrabutylammonium tetrafluoroborate, tetrabutylammonium hexafluorophosphate, tetraethylammonium tetrafluoroborate, tetraethylammonium hexafluorophosphate and triethylsulphonium bis(trifluoromethylsulfonyl)imide.

22. An electrolyte according to claim 11, wherein the electrolyte comprises acetonitrile solvent, a salt selected from the group consisting of tetrabutylammonium tetrafluoroborate, tetrabutylammonium hexafluorophosphate, tetraethylammonium tetrafluoroborate and tetraethylammonium hexafluorophosphate, and an additive in the form of a salt selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate, and triethylsulphonium bis(trifluoromethylsulfonyl)imide.

23. An electrolyte according to claim 11, wherein the electrolyte comprises acetonitrile solvent, tetraethylammonium tetrafluoroborate salt and trihexyl(tetradecyl)phosphonium tris(pentafluoroethyl)trifluorophosphate additive.

24. An electrolyte according to claim 1, wherein the additive is a non-ionisable compound which is different to said solvent.

25. An electrolyte according to claim 24, wherein the additive is selected from the group consisting of acetonitrile, γ-butyrolactone, N-butyronitrile, proprionitrile, valeronitrile and a halogenated or unhalogenated alkyl carbonate compound.

26. An electrolyte according to claim 1, wherein the solvent is selected from the group consisting of acetonitrile, γ-butyrolactone, N-butyronitrile, proprionitrile, valeronitrile and a halogenated or unhalogenated alkyl carbonate compound.

27. An electrolyte according to claim 1, wherein the electrolyte further comprises a co-solvent selected from the group consisting of dimethyl sulfoxide, butyl methyl sulfoxide, dimethyl formamide, N-methyl-2-pyrrolidine, N-butyl-2-pyrrolidone, dimethyl acetamide and sulfolane.

28. An electrolyte according to claim 11, wherein the salt contained in the electrolyte is selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate, tetrabutylammonium tetrafluoroborate, tetrabutylammonium hexafluorophosphate, tetraethylammonium tetrafluoroborate, tetraethylammonium hexafluorophosphate and triethylsulphonium bis(trifluoromethylsulfonyl)imide.

29. An electrolyte according to claim 24, wherein the salt contained in the electrolyte is selected from the group consisting of 1-butyl-1-methylpyrrolidinium tris(pentafluoroethyl) trifluorophosphate, ethyl-dimethyl-propylammonium bis(trifluoromethylsulphonyl)imide, 1-butyl-1-methyl-pyrrolidinium trifluoromethylsulfonate, trihexyl(tetradecyl)phosphonium tris(pentafluoroethyl)trifluorophosphate, 1-Butyl-1-methylpyrrolidinium bis[oxalato(2)]borate, Butyl-methyl-pyrrolidine ethyloctafluoroborate, Tetraethyl ammonium ethyloctafluoroborate, Tetramethylammonium ethyloctafluoroborate, Trihexyl(tetradecyl)phosphonium bis[oxalato(2)]borate, 1-Butyl-3-methylimidazolium hexafluorophosphate, 1-Butyl-3-methylimidazolium tetrafluoroborate, tetrabutylammonium tetrafluoroborate, tetrabutylammonium hexafluorophosphate, tetraethylammonium tetrafluoroborate, tetraethylammonium hexafluorophosphate and triethylsulphonium bis(trifluoromethylsulfonyl)imide.

30. A capacitor comprising first and second spaced electrodes and an electrolyte provided in the space defined between the electrodes, the electrolyte comprising a solvent; a salt comprising a first anion and a first cation; and an additive, wherein the additive is provided in a sufficient quantity to modify a voltage differential across an electric double layer associated with at least one electrode of said capacitor such that said voltage differential is closer to a predetermined voltage breakdown limit for the electrolyte and said at least one electrode than a voltage differential across an electric double layer associated with said at least one electrode and a further electrolyte comprising said solvent and said salt but no additive.

31. A capacitor according to claim 30, wherein the electrolyte is in accordance with claim 2.

32. A method for optimising an electrolyte for use in a capacitor comprising an anode, a cathode and an electrolyte comprised of a solvent, a salt comprising a first anion and a first cation, and an additive, the method comprising the steps of:
selecting an anode structure, a cathode structure and an electrolyte composition;
determining a positive voltage breakdown limit for the selected anode structure and electrolyte;
determining a negative voltage breakdown limit for the selected cathode structure and electrolyte;
arranging a test rig comprising a quantity of the selected electrolyte, a test anode having the selected anode structure and a test cathode having the selected cathode structure;
applying a voltage between the test anode and the test cathode;
varying the amount of the additive in the electrolyte composition to modify the voltage differential between the electrolyte and at least one of the test anode and the test cathode;
measuring a potential difference between the test anode and the electrolyte and a potential difference between the test cathode and the electrolyte for each of a plurality of different combinations of applied voltage and electrolyte compositions; and
using said measurements to select the optimum electrolyte composition for use in the capacitor in which the voltage differential between the electrolyte and said at least one of the test anode and the test cathode is closer to the corresponding positive and/or negative voltage breakdown limit than a further capacitor comprising an anode and a cathode having the same structures as the test anode and test cathode respectively and employing a further electrolyte comprised of said solvent and said salt but no additive.

33. A method in accordance with claim 32, wherein said plurality of different combinations of applied voltage and electrolyte compositions comprises at least two different applied voltages at each of at least two different electrolyte compositions.

34. A method in accordance with claim 32, wherein said plurality of different combinations of applied voltage and electrolyte compositions comprises at least a first applied voltage in combination with a first electrolyte composition; the first applied voltage in combination with a second electrolyte composition; a second applied voltage in combination with the first electrolyte composition; and the second applied voltage in combination the said second electrolyte composition.

35. A method in accordance with claim 32, wherein the steps of applying a voltage and varying the applied voltage comprise applying a plurality of different discrete voltages between the test anode and test cathode.

36. A method in accordance with claim 35, comprising applying each of the plurality of different discrete voltages in combination with each of a plurality of different discrete electrolyte compositions, and measuring said potential differences for each combination.

37. A method in accordance with claim 35, wherein said positive and negative voltage breakdown limits together define a theoretical maximum operational voltage window of the capacitor, and wherein each of said plurality of different discrete voltages is less than or equal to the theoretical maximum operational voltage window.

38. A method in accordance with claim 32, wherein the step of using said measurements to select an electrolyte composition comprises comparing the measured potential differences with the positive and negative voltage breakdown limits.

39. A method in accordance with claim 32, wherein the selected electrolyte composition is the composition at which the largest voltage can be applied between the test anode and test cathode with the potential difference between each of the test anode and test cathode and the electrolyte not exceeding the respective anode and cathode voltage breakdown limit.

40. A method in accordance with claim 32, wherein said potential differences are measured between the bulk electrolyte and the respective test electrode.

41. A method for manufacturing an electrochemical capacitor comprising an anode, a cathode, and an electrolyte, the method comprised of optimising the electrolyte using an optimisation method in accordance with claim 32 and constructing the capacitor with the selected anode and cathode structures and the selected electrolyte composition.

42. Use of an additive in an electrolyte to modify a voltage differential across an electric double layer associated with at least one electrode of a capacitor, the electrolyte further comprising a solvent and a salt comprising a first anion and a first cation, wherein the additive is provided in a sufficient quantity to modify said voltage differential across the electric double layer associated with said at least one electrode of said capacitor such that said voltage differential is closer to a predetermined voltage breakdown limit for the electrolyte and said at least one electrode than a voltage differential across an electric double layer associated with said at least one electrode and a further electrolyte comprising said solvent and said salt but no additive.

43. Use of an additive according to claim 42, wherein said electrolyte is in accordance with claim 2.
